(19) United States
(12) Patent Application Publication
(10) Pub. No.: US 2025/0252263 A1
(43) Pub. Date: Aug. 7, 2025

(54) Systems and Methods for Detecting Generated Text Through Rewriting Operations

(71) Applicant: The Trustees of Columbia University in the City of New York, New York, NY (US)

(72) Inventors: Junfeng YANG, New York, NY (US); Chengzhi MAO, New York, NY (US); Carl VONDRICK, New York, NY (US); Wei HAO, New York, NY (US)

(73) Assignee: The Trustees of Columbia University in the City of New York, New York, NY (US)

(21) Appl. No.: 19/038,962

(22) Filed: Jan. 28, 2025

Related U.S. Application Data
(60) Provisional application No. 63/627,909, filed on Feb. 1, 2024.
(60) Provisional application No. 63/745,979, filed on Jan. 16, 2025.

(51) Int. Cl. G06F 40/30; G06N 20/00

(52) U.S. Cl. CPC G06F 40/30; G06N 20/00

(57) ABSTRACT

Disclosed are systems, methods, and other implementations, including a method for detecting machine-generated content that includes receiving written source input at a machine learning system configured to transform written content into resultant transformed content, and generating by the machine learning system one or more rewritten versions of the written source input, with the one or more rewritten versions being semantically similar to the written source input. The method further includes deriving one or more rewriting change measurements, for the one or more rewritten versions, representing extent of differences between the one or more rewritten versions and the written source input, and determining likelihood that the written source input was machine generated based at least on the derived one or more rewriting change measurements.

### CROSS-REFERENCE TO RELATED APPLICATIONS

This application claims priority to, and the benefit of, U.S. Provisional Application No. 63/627,909, entitled “Systems and Methods for Detecting Generated Text Through Rewriting Operations” and filed Feb. 1, 2024, and U.S. Provisional Application No. 63/745,979, entitled “Systems and Methods for Detecting Generated Text Through Rewriting Operations” and filed Jan. 16, 2025, the contents of all of which are incorporated herein by reference in their entireties.

### BACKGROUND

Large language models (LLMs) demonstrate exceptional capabilities in text generation, such as question answering and executable code generation. The increasing deployment and accessibility of those LLM also pose serious risks. For example, LLMs create cybersecurity threats, such as facilitating phishing attacks, generating propaganda, disseminating fake or biased content on social media, and lowering the bar for social engineering. LLM can also lead to academic dishonesty, can introduce security vulnerabilities to programs, and can contaminate foundation models' training.

Detecting and auditing those machine-generated text is thus crucial to mitigate the potential downside of LLMs. Machine learning algorithms inherently mimic the syntax and writing of a human being. To be able to tell between artificial and written text represents an area of technological challenge that impacts a plurality of fields, including journalism, public discourse, cybersecurity, social media, creative writing, academic writing, and many other.

Various methods for detecting machine-generated text have been proposed. Most of these methods are based on classifier implementations that employ pre-trained models, extracting hand-crafted features and heuristics, such as loss curvature and rewriting distance, and applying thresholds to distinguish LLM from human data. However, these thresholds are highly domain-dependent, obfuscating the establishment of a universal detection standard.

### SUMMARY

The proposed framework described herein is directed to technology for discerning machine-generated text from human-written text using large language models (LLMs). The framework is based on the finding that when LLMs are prompted to rewrite portions of text, they tend to make greater edits to human-written text than AI-generated text. The technology of the proposed framework utilizes a symbolic word output from LLMs to reduce any reliance on specific machine learning architecture, boosting its reliability, robustness, generalizability, and adaptability. The rewriting-based procedure greatly improves detection for several established paragraph-level detection benchmarks with F1 detection score gains up to 29 points. In addition, this technology remains robust even when the text generation source is aware of the detection mechanism. In summary, this technology exploits a common occurrence in machine learning models to efficiently detect machine learning-generated text. The rewrite-based detection framework is also referred to as “geneRative AI Detection viA Rewriting,” or “Raidar.”

In various embodiments, the proposed framework for detecting whether input content is machine-generated or human-generated includes a fine-tuning optimization process applied to the rewrite (e.g., LLM-based) detector, that trains the rewrite system (engine), across a diverse set of domains, to perform more edits when the input to the rewrite engine is human-generated data, and to perform fewer edits when rewriting machine-generated (e.g., LLM-generated) data. Unlike traditional classifiers, which often struggle to generalize among different domains, the proposed framework leverages the inherent tendency of LLMs to modify their own output less frequently, and maximizes its potential by focusing on learning from the hard samples that are not easily separated by simple rewriting. The proposed training/optimization approach is referred to as the “L2R” (Learn to Rewrite) process (with the resultant trained rewrite-based detection framework also being referred to as an “L2R-based detection framework”).

The proposed L2R-based framework can capture the rich structure of LLM content, which can be further strengthened through targeted training. As will be discussed in greater detail below, a diverse AI text dataset, encompassing 21 distinct domains (e.g., finance, entertainment, cuisine, etc.), representing diversely distributed content and corresponding LLM-generated text, was developed to train the rewrite system, providing during training human-generated data across diverse domain, and semantically equivalent AI-generated (e.g., LLM-generated) content, in order to fine-tune the rewrite system to perform extensive edits on human-generated content, and fewer edits on AI-generated content.

Accordingly, in some variations, a method (typically performed during runtime) for detecting machine-generated content is disclosed that includes receiving written source input at a machine learning system configured to transform written content into resultant transformed content, and generating by the machine learning system one or more rewritten versions of the written source input, with the one or more rewritten versions being semantically similar to the written source input. The method further includes deriving one or more rewriting change measurements, for the one or more rewritten versions, representing extent of differences between the one or more rewritten versions and the written source input, and determining likelihood that the written source input was machine generated based at least on the derived one or more rewriting change measurements.

Embodiments of the method may include at least some of the features described in the present disclosure, including one or more of the following features.

Determining the likelihood that the written source input was machine generated may include one or more of, for example, comparing the one or more rewriting change measurements to respective one or more pre-determined threshold values and/or analyzing at least the rewriting change measurement with a trained machine learning linear readout model configured to predict likelihood that the written source was machine generated.

Generating by the machine learning system the one or more rewritten versions of the written source input can include generating the one or more rewritten versions by the machine learning system implementing a large language model (LLM) in response to one or more requests, received by the machine learning system, with each of the one or more requests comprising a rewriting prompt and the written source input.

Generating the one or more rewritten versions of the written source input can include generating respective edited content for corresponding ones of the one or more rewritten versions, the respective edited content representative of content differences between the one or more rewritten versions and the written source input.

Generating by the machine learning system one or more rewritten versions of the written source input may include generating multiple rewritten versions of the written source input responsive to respective multiple prompts representative of rewriting instructions, the multiple rewritten versions resulting in increased rewritten diversity produced from the written source input.

Generating by the machine learning system one or more rewritten versions of the written source input may include applying, using a machine learning system, a semantic transformation to the written source input to generate semantically transformed content, rewriting the semantically transformed content, by the machine learning system, to generate rewritten semantically transformed content, and applying to the rewritten semantically transformed content, using a machine learning system implementing an inverse semantic transformation model, an inverse semantic transformation of the semantic transformation to produce a corresponding rewritten version for the written source input.

Deriving the one or more rewriting change measurements can include generating an iterative rewritten version based on one of the one or more rewritten versions of the written source input, and computing an edit distance between the one of the one or more rewritten versions and the iterative rewritten version.

Deriving the one or more rewriting change measurements may include deriving one or more of, for example, a bag-of-words edit score and/or a Levenshtein score.

The machine learning system can be configured to rewrite human-written input content with a lower degree of invariance than for a rewrite machine-generated input content.

The machine learning system may be optimized to rewrite human-written input content with more edits than for a machine-generated input content based on a training dataset that includes multiple human-generated content records drawn from one or more data repositories with content covering a plurality of subject matter domains, respective counterpart machine-generated content records, semantically equivalent to the multiple human-generated content records, produced by one or more other, different, LLM systems, and respective prompts selected at random, for each respective human-generated content record, from a data repository of a plurality of prompts.

The machine learning system may be optimized based on minimizing cross-entropy loss assigned to each training dataset record, with the cross-entropy loss representing edit distance between each content record and a corresponding rewritten output produced for the each content record.

The minimizing of the cross-entropy loss can include performing a calibration loss imposing a threshold value t on an absolute value of the loss on each given input record.

In some variations, a method (typically executed during training time, or intermittently during runtime when updating is needed, or when the system is offline) for optimizing a detection system for detecting machine-generated content is disclosed that includes accessing a training data set for training a rewrite LLM system to rewrite human-written input content with more edits than for a machine-generated input content, the training set comprising multiple human-generated content records drawn from one or more repositories with content covering a plurality of subject matter domains, respective counterpart machine-generated content records, semantically equivalent to the multiple human-generated content records, produced by one or more other, different, LLM systems, and respective prompts selected at random, for each respective human-generated content record, from a data repository of a plurality of LLM-system prompts. The method further includes configuring adjustable parameters of the rewrite LLM system according to an optimization procedure that uses the training dataset to adjust the parameters to cause the rewrite LLM system to rewrite a human-written input content with more edits than for a machine-generated input. Configuring the adjustable parameters according to the optimization procedure includes minimizing cross-entropy loss assigned to each training dataset record, with the cross-entropy loss representing edit distance between each content record and a corresponding rewritten output produced for the each content record.

Embodiments of the method for optimizing the detection system may include one or more of the features described in the present disclosure, including one or more of the features described above in relation to the method for detecting machine-generated content, as well as one or more of the following features.

Minimizing the cross-entropy loss may include performing a calibration loss process that imposes a threshold value t on an absolute value of the loss on each given input record.

The method may further include substituting, for one of the counterpart machine-generated content records, one or more words of the one of the counterpart machine-generated content records with one or more substitute words determined by an auxiliary LLM system, with the one or more substitute words maintaining part-of-speech consistency and minimally increase perplexity as that of the respective one or more words of the one of the counterpart machine-generated content records.

In some variations, a system for detecting machine-generated content is provided that includes an interfacing unit to receive written source input, and one or more computing devices implementing one or more machine learning models. The one or more computing devices are configured to generate by a machine learning system configured to transform written content into resultant transformed content, one or more rewritten versions of the written source input, with the one or more rewritten versions being semantically similar to the written source input, derive one or more rewrite change measurements, for the one or more rewritten versions, representing extent of differences between the one or more rewritten versions and the written source input, and determine likelihood that the written source input was machine generated based at least on the derived one or more rewriting change measurements.

In some variations, a non-transitory computer readable media is provided that includes computer instructions executable on a processor-based device to receive written source input at a machine learning system configured to transform written content into resultant transformed content, generate by the machine learning system one or more rewritten versions of the written source input, with the one or more rewritten versions being semantically similar to the written source input, derive one or more rewrite change measurements, for the one or more rewritten versions, representing extent of differences between the one or more rewritten versions and the written source input, and determine likelihood that the written source input was machine generated based at least on the derived one or more rewriting change measurements.

Embodiments of the system and the computer readable media may include one or more of the features described in the present disclosure, including one or more of the features described above in relation to the methods.

Other features and advantages of the invention are apparent from the following description, and from the claims.

### BRIEF DESCRIPTION OF THE DRAWINGS

These and other aspects will now be described in detail with reference to the following drawings.

FIG. 1 is a diagram of a rewrite-based detection architecture and pipeline, including a training and fine-tuning section to implement an L2R-optimized rewrite-based detection framework system.

FIG. 2 includes histograms showing rewriting similarity, for human and machine (AI) texts in two different subject matter domains, performed before and after fine-tuning of a Llama rewrite model.

FIG. 3 includes examples of outputs produced in response to excerpts produced with a regularly trained rewrite system and fine-tuned rewrite system.

FIG. 4 includes graphs illustrating a calibration process that may be used in conjunction with a fine-tuning training process for the rewrite detection system.

FIG. 5 includes examples of rewrite output produced from human-generated content excerpts and their AI-generated counterparts.

FIG. 6 is a flowchart of an example procedure for detecting machine-generated content.

FIG. 7 is a flowchart of an example procedure for optimizing a detection system for detecting machine-generated content.

FIG. 8 includes a table providing performance results using adaptive prompts aiming to evade the rewrite-based detector.

FIG. 9 includes a table providing performance data across diverse tasks.

FIG. 10 includes a table with performance data relating to the effectiveness of detection using various rewriting large language models.

FIG. 11 includes graphs showing the detection F1 scores for various prompts across three datasets.

FIG. 12 includes a graph illustrating detection performance as input length increases.

FIG. 13 includes a graph showing performance results, measured by the Area Under the Receiver Operating Characteristic Curve (AUROC) scores, achieved with an L2R-based rewrite detection framework compared with Fast-DetectGPT and GPT-2 Detector.

FIG. 14 includes a table of detection performance measured in accuracy and F1 score for a Gemini rewrite system, a Llama rewrite system, and a Learning-to-Rewrite-based rewrite system.

FIG. 15 includes a table providing a comparison of accuracy and F1 scores for different rewrite models on the nondiverse and diverse datasets.

FIG. 16 includes a graph with training loss curves for the rewrite model described herein.

FIG. 17 includes a table providing a comparison of accuracy and F1 scores for fine-tuning a Llama rewrite system with and without the calibration method.

FIG. 18 includes a table with data regarding performance of the RAFT technique against six target detectors.

FIG. 19 includes a table with performance results corresponding to the perplexity of text after different attacks.

FIG. 20 includes examples of the effect of the RAFT on a sample text generated by GPT-3.5-turbo.

FIG. 21 includes examples of text samples generated by an LLM, and the resultant text samples, following attacks by a query-based word substitution attack and the RAFT attack.

FIG. 22 includes data showing the effect of adversarial training using the RAFT attack scheme on performance of a rewrite-based detection framework.

Like reference symbols in the various drawings indicate like elements.

### DESCRIPTION

The proposed framework described herein is directed to technology for discerning machine-generated text from human-written text using large language models (LLMs). The framework is predicated on a finding that when LLMs are prompted to rewrite portions of text, they tend to make greater edits to human-written text than AI-generated text. A key principal underlying the proposed framework is that text from auto-regressive generative models retains a consistent structure, which another such model will likely also produce at a low loss and treat it as high quality.

The proposed framework can thus be used in situations where it is important to determine the authenticity of verbal content (whether in written or oral form; if content is provided in oral form, speech recognition processing would need to first be performed). For example, in academia, the proposed framework can be used to assess whether submitted graded work was in fact written by the student submitting it. The framework can similarly be used in other areas where decisions need to be made based on the assessed quality of a person's own work product (whether at a job interview, when reviewing written submissions, as in legal setting, etc.) In another example, machine-generated content distributed on social media can be more easily detected, and marked accordingly (to let users know whether they are reading human-written content, and to avoid propaganda). In a further example, the proposed framework can be used in cyber-security applications. For instance, the framework's effectiveness to detect machine-generated content at paragraph-granularity allows the framework to detect, for example, phishing-attack e-mails (in which the incoming e-mail tries to fool the recipient to take certain actions that compromise the security of the user's information and accounts), or spying tools. In yet another example, companies that collect and manage large volume of data (for searching purposes, for LLM training, etc.) need to be able to process those large volumes of data, and detect quickly what content is machine generated and what content is authentic human data (in some embodiments, content determined to be human-written may be archived in special repositories). Examples of companies/services that collect such large volumes of data include discussion forums and Q/A platforms such as twitter.com, reddit.com, stackoverflow.com, quora.com, yelp reviews, Amazon product reviews, etc. For such services, human-written content is preferred to machine-generated content.

To improve the performance and robustness of the rewrite-based detection framework proposed herein, the framework includes a training/optimization procedure (referred to as Learn-to-Rewrite, or L2R) for the rewrite LLM implementation, to configure the rewrite LLM implementation to produce minimal edits for LLM-generated content and more edits for human-written text, deriving a distinguishable and generalizable edit distance difference across different domains. Experiments on text from 21 independent domains and three popular LLMs (e.g., GPT-40, Gemini, and Llama-3) used to generate semantic equivalent content corresponding to the human-generated content, show that the proposed L2R-based rewrite detection framework outperforms state-of-the-art zero-shot classifiers by up to 20.6% on AUROC score and the rewriting classifier by 9.2% on F1 score. The results show that detection systems based rewrite LLM's can effectively detect machine-generated text, and achieve high performance and robustness characteristics when properly trained.

Thus, let F(⋅) be a rewrite large language model. Given an input text x, the goal is to classify the resultant output label y, to indicate whether the input x was generated by a machine. Under the proposed approach, given the same rewriting prompt, such as asking the LLM model to “rewrite the input text,” an LLM-generated text (also referred to as “machine-generated text” or “AI-generated text”) will be accepted by the language model as a high-quality input with inherently lower loss, which leads to few modifications at rewriting. In contrast, a human-generated text will be unfavored by LLM and edited more by the language models.

The level of invariance between the output and the input can be used to measure how much the rewriting LLM prefers the given input. LLM will produce relatively invariant output when rewriting LLM-generated text (whether produced by the same LLM system, or by some other LLM) because another auto-regressive prediction will tend to produce text in a similar pattern (this is referred to as the invariance property).

Briefly, given data x, a transformation is applied to the data by prompting an LLM (such as OpenAI's ChatGPT, Meta Al's LLAMA, etc., which receives and processes prompts, in some cases for a fee; alternatively, local servers to implement private LLM models may be used instead) with a prompt p. If the input x was machine generated, then the transformation p aims to cause the LLM to rewrite the input with only a small change(s) (or may even output the same content as the input). The invariance measurement is computed as L=D(F(p, x), x), where D(⋅) denotes the modification distance (edit distance). In some embodiments, the prompt p to assess this invariance may be manually created, or may be automatically created. Generally, the particular prompt used can cause the rewrite LLM to achieve most of the invariant behavior for machine-generated content, and to achieve variant behavior for human-generated text/content. Therefore, in some embodiments, several different prompts may be applied to a particular input x, to produce multiple rewrites (thus increasing the rewrite diversity), based on which a score or measure of change/variance (or conversely, a measure of similarity or invariance) between the input x and the rewrite outputs can be computed (e.g., as an average of the scores computed from the multiple different rewrites).

A procedure (algorithm) for detecting LLM generated content via output invariance is provided below.

Procedure 1: Detecting LLM Generated
Content via Output Invariance

| | |
|---|---|
| 1: | Input: Text input x, rephrase/rewrite prompt Pₖ, where k = 1, ..., K. |
| 2: | Output: Class prediction ŷ |
| 3: | Inference: |
| 4: | for k = 1, ..., K do |
| 5: | Obtain LLM output Sₖ = F(Pₖ, x) |
| 6: | Calculate bag-of-words edit Rₖ and/or the Levenshtein Score Dₖ |
| 7: | end for |
| 8: | Make final prediction via y = C([R₁, R₂, ..., R_{K}, D₁, D₂, ..., D_{K}]) |

As noted, performance of the rewrite-based detection framework can be enhanced through the L2R training approach in which the rewrite system is specifically trained to rewrite more on LLM-generated inputs and less on human generated inputs.

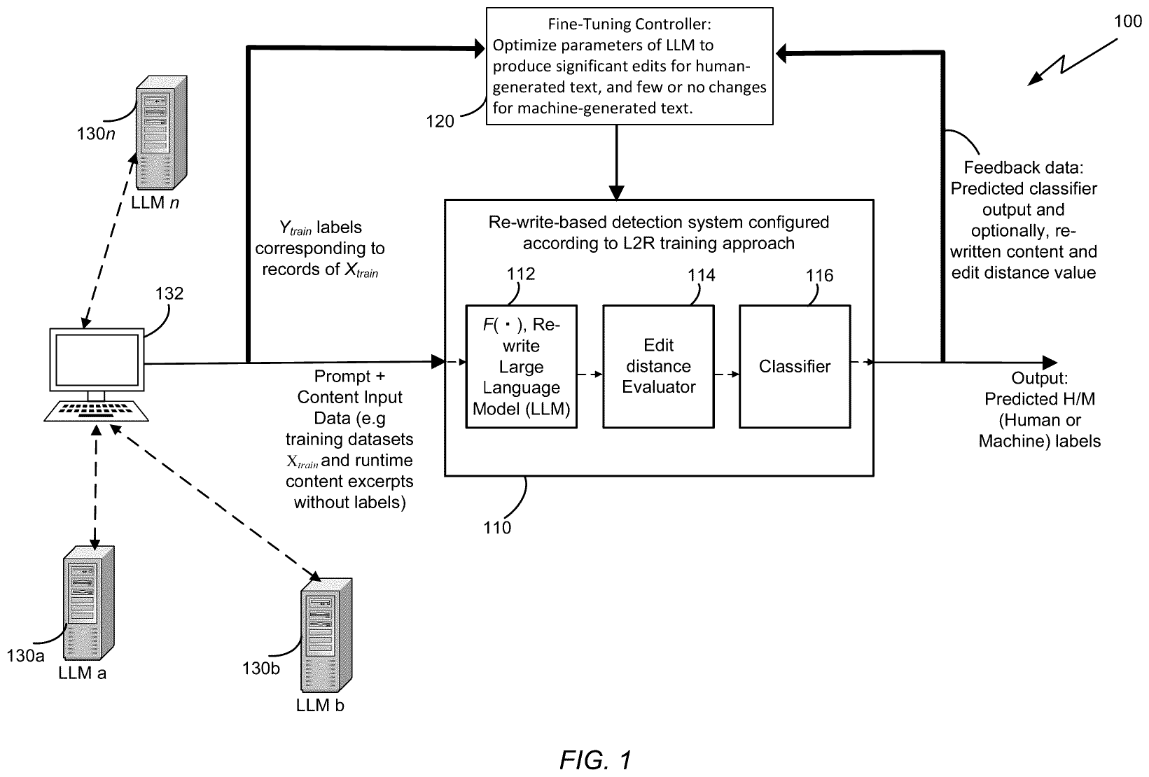

More particularly, with reference to FIG. 1, a block diagram depicting a rewrite LLM architecture and pipeline 100, including the training and fine-tuning block for an L2R training approach (typically applied during training time, prior to commencement of rewriting operations during runtime, but also applied when occasional updated are needed and/or when the system is offline) is shown. Rewriting input via LLM and then measuring the change proves to be a successful way to detect LLM-generated content. Initially, the LLM engine(s) (e.g., LLAMA or ChatGPT) of the rewrite-based detection framework is trained/configured. The system produces or retrieves a held-out/training data that includes an input text set, Xₜᵣₐᵢₙ comprising human generated text, corresponding rephrased (but semantically equivalent) counterpart AI-generated text, and corresponding labels set Y train that includes the labels identifying the human-generated text in Xₜᵣₐᵢₙ (for example, an “H” label for text known to have been human-generated and “M” for counterpart records known to have been generated by a machine). Details of how the training data is assembled are provided below. A rewrite LLM-based detection system (operator), F(⋅), 110 is prompted to rewrite the input x∈Xₜᵣₐᵢₙ using a prompt p. The resultant rewriting output is denoted F (p, x). Examples of prompts that can be used to request the LLM system 110 to produce a rewritten output is “Refine this for me please: . . . x”, “Please rewrite this content in your own words:”, “Make this text more formal and professional:”, “Make this text more casual and friendly:”, “Rephrase this text in a more elaborate way:”, “Reframe this content in a more creative way:”, “Can you make this text sound more enthusiastic?”, “Rewrite this passage to emphasize the key points:”, “Help me polish this:”, “Rewrite this for me:”, “Help me rephrase it, so that another GPT rewriting will cause a lot of modifications”, etc.

The training data record x∈Xₜᵣₐᵢₙ is provided to the system 110, which includes a rewrite LLM system (engine) 112 that is being configured and optimized (through the training data) to rewrite input excerpts that produce significant edits for input content that was generated by a human, and far fewer edits (possibly none) for input content that was generated by a machine (e.g., by some other independent LLM system such as ChatGPT). The rewritten output of the rewrite LLM engine 112 provides the rewritten output, as well as the respective input content (text) that produced that particular output to an edit distance evaluator 114 configured to compute an edit distance, D(x, F(p, x)), that represents the extent of the rewritten edits performed by the rewrite LLM engine 112 on the input text (whether the input text is part of the training dataset, or a runtime record). During training, every record x∈Xₜᵣₐᵢₙ undergoes a rewritten operation by F(⋅), and has its edit distance D(⋅) computed relative to the rewrite output. An example of a process to derive an edit distance is one based on the Levenshtein distance, which is defined as the minimum number of insertions, deletions, or substitutions required to transform one content element (e.g., the input text) into another content element (e.g., the rewritten output text). The edit distance (also referred to as a similarity score) can then be computed according to:

$${D}_{k} ( x , {s}_{k} ) = 1 - \frac{Levenshtein ( {s}_{k} , x )}{max ( len ( {s}_{k} ) , len ( x ) )}$$

With continued reference to FIG. 1, the computed edit distance D(x, F(p, x)) is provided to a classifier 116 that, in some embodiments, compares the edit distance to a threshold, t, to determine if the edit distance is sufficiently high that the input text was likely generated by a human. During training, and as will be discussed below in greater detail, the output, which may include the labelled output produced by the classifier, and optionally, the actual edit distance score and/or the rewrite output produced by F(⋅), are provided to a fine-tuning controller 120 to perform an optimization procedure (using the known input record and the known actual associated label indicating if the input record was generated by a human or a machine).

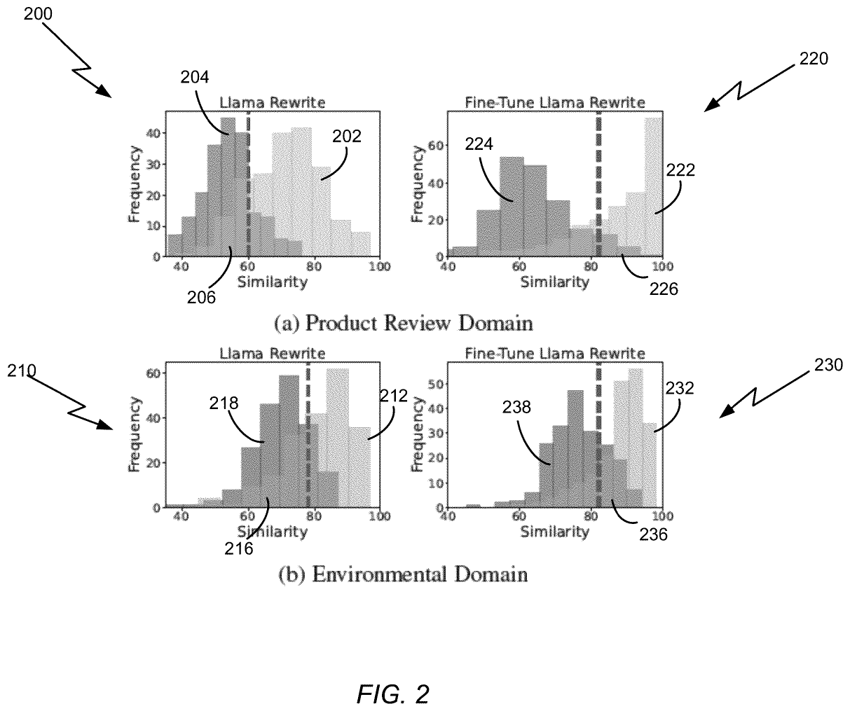

The classifier 116 may be a simple threshold-decision classifier, or a more sophisticated trained classifier, such as logistic regression or decision tree classifier. It is noted that for threshold-based classifiers, in which the similarity scores are compared to a threshold to predict if the input text was written by a machine or a human, the threshold of rewriting with a standard (vanilla) LLM often varies from one domain to another, resulting in difficulties to generalize for new domains. On the other hand, LLM implementations that are based on the L2R framework described herein, in which the LLM is specifically trained for rewrite functionality intended to determine whether the input text was generated by a human or a machine, shows improved performance in detecting human versus machine generated input contents. Consider, for example, FIG. 2, which includes histogram 200-230 showing rewriting similarity, for human and machine (AI) texts, before and after fine-tuning of a Llama rewrite model, performed for two different subject matter domains (product review domain and environmental domain). In the histograms, human-generated distributions of environmental text are marked 218 and 238, AI-generated distributions of environmental text are marked 206, 216, 226, and 236, human-generated distribution for product review texts are marked 204 and 224, and AI-generated distributions for product review texts are marked 202, 212, 222, and 232. The simple rewrites of these domains (i.e., with an LLM not specifically configured for rewriting operations in either of these domains) are difficult to separate by a single threshold (marked by a thick dashed line), as more particularly illustrated in histograms 200 and 210. By being trained to rewrite, especially for the objective of determining whether the source text is human or machine-generated, it becomes more practical to separate rewritten text and determine, e.g., by a threshold, whether the input content was generated by a human or by a machine.

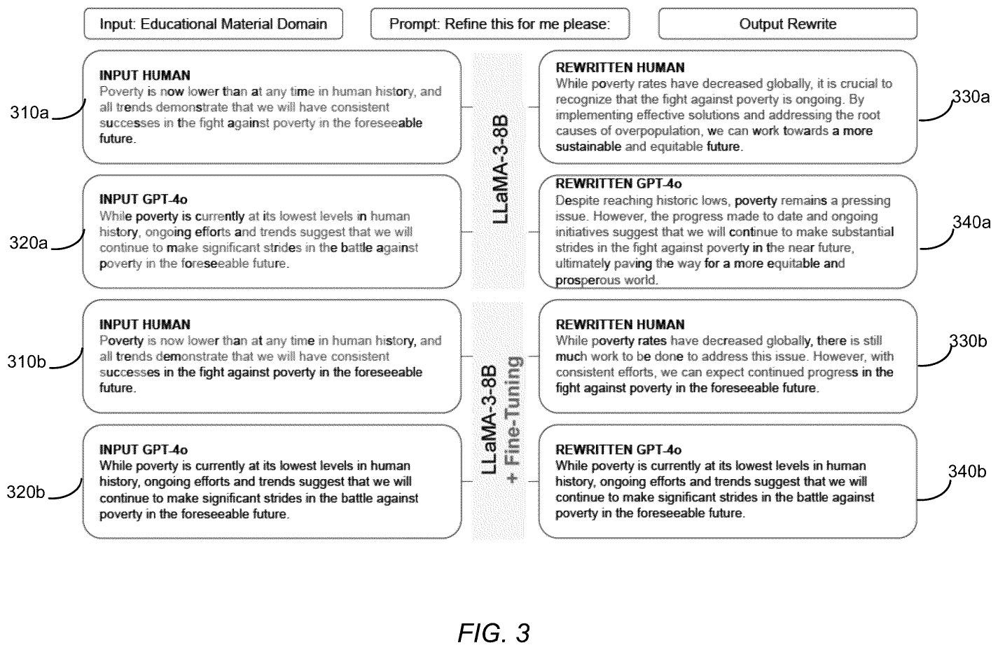

As noted, the proposed rewrite detection framework works on the premise that human-written and Al generated text would cause different amounts of rewrites, and that a boundary (e.g., a threshold point) can be drawn to separate both distributions. In some embodiments, the LLM system can be fine-tuned (according to the L2R approach described herein) such that a rewrite model F′(⋅) is configured to produce relatively high rewritten output content for human generated content (texts), while leaving relatively unmodified, as much as possible, AI-generated content (texts). To illustrate, consider, with reference to FIG. 3, examples of outputs produced in response to a first input excerpt (corresponding to 310a and 310b, with each of those excerpts differing only in the illustrated level of edits caused by rewriting) produced by a human and a second input 320 (corresponding to 320a and 320b), semantically similar to the excerpt 320, produced by an LLM generative system (in this case, GPT-40). FIG. 3 shows two instances in which each of the input excerpts was processed by a rewrite LLM (LLaMA-3-8B). In the first instance, the input excerpts 310a and 320a are processed by a regularly trained LLaMA-3-8B LLM to produce output excerpts 330a and 340a, while in the second instance the input excerpts 310b and 320b are processed by a fine-tuned implementation of the LLAMA LLM, in which the LLM was more extensively trained (and thus optimized) for rewrite functionality covering various subject matter domains, to produce output excerpts 330b and 340b. In each of the illustrated input excerpts, the darker text indicates unchanged text, while the fainter colored text indicates words (or characters) that were deleted in the rewritten output excerpts. Similarly, in each of the rewritten output excerpts 330a, 330b, 340a, and 340b, the darker words (or characters) indicate unedited/rewritten words (as compared to the input source), while fainter words/characters represent added words/characters. As can be seen from output excerpts 330a and 340a, the rewriting operations performed on both human-written content 310a and the semantically similar AI-generated content 320a using a regularly trained rewriting LLM system resulted in significant edits for both the human-generated and AI-generated content, making it difficult to distinguish (and thus determine) whether the rewrite operations were performed on human or machine generated content. On the other hand, when processed by a fine-tuned rewriting LLM detection system, the human-generated content resulted in a significant different rewritten output, but the machine-generated input content resulted (in this example) in an unmodified output rewritten content (at block 340b). Specifically, the Levenshtein edit ratio for the rewrite of the human-generated content 310b was 0.71, while the Levenshtein edit ratio for the rewrite of the AI-generated input excerpt 320b was 0 using an L2R-optimized rewrite-based detection system.

With continued reference to FIG. 1, the fine-tuning controller 120 controls, among other things, the optimization process applied during training to, for example, minimize a loss metric between predictions made by the machine learning network and the ground truth of the training samples (the training samples include the training input content (text-based excerpts) produced by humans, and their semantically similar Al counterparts produced by one or more LLM systems). The optimization of the rewrite LLM system according to a selected objective causes the LLM system (which may be implemented according to various machine-learning architectures) to adjust its configurable parameters from its pre-training (and pre-optimized) configuration to an optimized configuration in which the ground truth outputs converge to the predicted outputs (e.g., the predicted H/M labels converge to the ground truth labels defined by Yₜᵣₐᵢₙ). The optimization process can be performed using different types of optimization processes, including, for example, a gradient descent procedure, or some other procedure. Based on the optimization metric (be it a loss metric or some other metric) produced in response to processing of input training data, the controller can adjust one or more sets of adjustable parameters that will then be used by the network during the subsequent iteration. The controller, in some embodiments, can be configured to adjust the weights of weighted connections between layers of the LLM implementation, adjustable parameters that control the behavior of one or more of the machine learning elements (e.g., behavior of neurons in a neural-network-type architecture), etc. The adjustment of the adjustable parameters of the LLM system can, in turn, adjust the behavior of the LLM system to thus steer the configuration of the system 110 to an optimal state in which human-generated inputs and machine-generated inputs result in different edit distance scores that are readily different, and which can be processed by a threshold-based classifier to produce a likely predicted output (e.g., “H” or “M” label to denote “human” or “machine”).

In some embodiments, the fine-tuning implementation of the controller 120 can be defined as follows. Given a human-generated text Xₕ∈Xₜᵣₐᵢₙ (with Xₜᵣₐᵢₙ being a training dataset) and AI-generated text Xₐ∈Xₜᵣₐᵢₙ, the objective for optimizing the rewriting LLM system becomes:

$$max \{ D ( {X}_{h} , {F}^{′} ( p , {X}_{h} ) ) - D ( {X}_{a} , {F}^{′} ( p , {X}_{a} ) ) \} \qquad ( 1 )$$

In other words, the objective is to maximize the difference between the edit distance resulting from rewriting human-generated content (i.e., by causing the edit distance for rewriting human-generated content to be as large as possible) and the edit distance resulting from rewriting AI-generated content (i.e., by causing the edit distance for rewriting of AI-generated content to be as small as possible).

Since the edit distance is not differentiable, the cross-entropy loss L(⋅) function assigned to the input x by F′(⋅) is used as a proxy to the edit distance. As a result, for each of input x with a label of, for example, y=1 (for AI content) or 0 (for human content), the model output is optimized based on the following loss function:

$$min \{ L ( {X}_{train} ) \cdot ( 2 ( y = 1 ) - 1 ) \}$$

where [symbol] is an indicator function that maps elements of a subset to ‘1’, and all other elements to ‘0’, such that, in this example, if the condition (in this case, y=1) is true, the indictor function returns a ‘1’, but otherwise returns ‘0’.

In this way, the sign of the loss of the human texts is flipped. Since the overall loss would be minimized, this effectively encourages the rewrites to be different from human input and to be more similar (and possibly identical) to the AI-generated input.

When fine-tuning the rewrite model of the above minimization expression, the rewrite model aims to make more edits on human-generated text and fewer edits on machine (AI)-generated content. However, without posting regularization and constraint on the unbounded loss, the rewrite model takes the risk of being corrupted (e.g., producing verbose output for all rewrites, and over-fitting with more edits on human-generated text rewrites). Therefore, to mitigate this potential problem, in some embodiments the L2R framework may use a calibration loss process during the fine-tuning operations to inhibit/prevent over-fitting by imposing a threshold value t on the absolute value of the loss on each given input. For human text Xₕ, a gradient backpropagation is applied only if the absolute loss L (Xₕ)<t. For AI-generated input content Xₐ, backpropagation is applied only if L(Xₐ)>t. Otherwise, the gradient is set to 0. These conditions can be expressed as follows:

$$min \{ ( L ( {X}_{train} ) \cdot ( 2 ( y = 1 ) - 1 ) ) \cdot ( ( y = 1 ⋀ L ( X ) \leq t ) ⋁ ( y = 0 ⋀ L ( X ) > ) ) \}$$

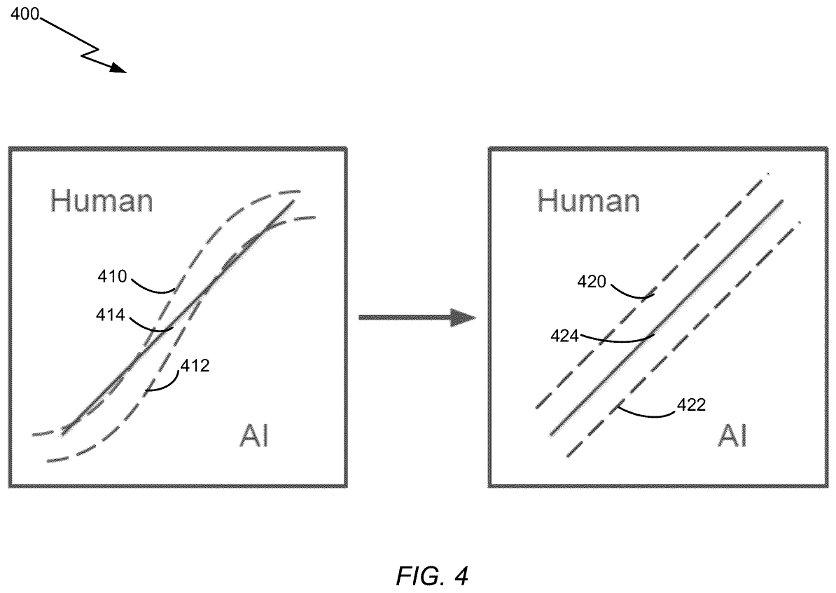

Therefore, rather than minimizing the loss proxy, the objective becomes separating the distribution of human and AI rewrites to two ends of the threshold t. To achieve this objective, it is not necessary to modify model weights when its rewrite falls in its corresponding distribution already. Instead, all that is needed is to apply gradient update when a rewrite is undesirable. This process is depicted in FIG. 4, illustrating a calibration process 400 that may be used in conjunction with the fine-tuning process. The calibration process includes first finding a threshold t that is represented by a line 414 that is positioned approximately between the distributions of human and AI rewrite distances (depicted by the dashed approximate distribution boundaries 410 and 412). Then, the rewrite model is fine-tuned (by the fine-tuning controller 120) to shift the two distributions to opposite ends of the threshold so that classification (machine-generated versus human-generated) performed by the classifier 116 would be facilitated (e.g., could be more easily performed).

To determine the threshold, t, a forward pass is performed using the rewrite model before fine-tuning it on Xₜᵣₐᵢₙ, optionally training a logistic regression model on all loss values. The threshold t can be derived from the weight and the intercept of the logistic regression model.

Existing classifiers are evaluated on a common set of data such as XSum, SQUAD, Writing Prompts, and other. However, it is arguable that these datasets only represent a tiny subset (e.g., dated data or restricted number of domains) of all human-generated and machine (AI)-generated data available, which suggests a problem of over-fitting (making it unclear how these classifiers would perform when deployed in the real world). To ensure a robust detection model (i.e., to determine human-generation versus machine-generated for an input content), and to generalize the implementations described for real world use, it is important to capture the distribution of a diverse set of real-world data originating from distinct domains that are generated by different source models and prompts. Thus, a multi-domain, diversely-prompted training dataset for AI-generated text detection was developed. For the proposed training dataset, human-written data was collected from 21 domains (e.g., finance, entertainment, and cuisine) that were distinct to each other (additional subject matter domains can, of course, be used). Examples of the domains and the respective sources that were used to provide content for the implementations described herein included:
AcademicResearch—Arxiv abstracts;
ArtCulture—Wikipedia;
Business—Wikipedia;
Code—Code snippets;
EducationalMaterial—Ghostbuster essays;
Entertainment—IMDb dataset (IMDb, 2024), and Stanford SST2;
Environmental—Climate-Ins;
Finance—Hugging Face FIQA;
FoodCuisine—Kaggle fine food reviews;
GovernmentPublic—Wikipedia
LegalDocument—CaseHOLD;
Creative Writing—Writing Prompts;
MedicalText—PubMedQA;
NewsArticle—Xsum;
OnlineContent—Hugging Face blog authorship;
PersonalCommunication—Hugging Face daily dialogue;
ProductReview—Yelp reviews;
Religious—Bible, Buddha, Koran, Meditation, and Mormon;
Sports—Olympics website (Olympics, 2024);
TechnicalWriting—Scientific articles; and
TravelTourism—Wikipedia

During evaluation and testing of the proposed L2R framework described herein, content that appeared after Nov. 30, 2022 (the release date of ChatGPT (OpenAI, 2020)) was filtered out. With human-generated data collected, machine (AI)-generated counterpart data was produced for each of the entries. Conventionally, AI data can be generated by prompting one of several commercially available LLM to either rewrite the given text, or continue writing after a given prefix. It is noted that while a single standard prompt may be used generate the AI counterpart content, the resultant training set might not completely capture the diversity of prompts that might appear in the real world scenario. For example, a potential way to bypass a human-generated content versus AI-generated content detection is by using a prompt such as “Help me rephrase it, so that another GPT rewriting will cause a lot of modifications:”, which suggests that data generated by different prompts yields different distributions. Therefore, in produced machine-generated content for the R2L-training framework described herein, a dataset of 200 rewrite prompts (some of which have been mentioned above) was constructed, with each prompt being a slightly different instruction that could be asked by a user. Then, when generating an AI-generating counterpart content for some particular human-generated content excerpt, the prompt used is a randomly selected prompt from the prompt dataset (other prompt-selection approaches could be used), to facilitate having the rewrites be slightly different in distribution.

To generate the counterpart AI-generated content for human-generated content used to implement the proposed R2L framework (e.g., the AI-generated samples 320a-b of FIG. 3 are the counterparts of the human-generated excerpts 310a-b), three state-of-the-art LLMs for text generation were used, including GPT-40 (OpenAI, 2024), Gemini 1.5 Pro, and Llama-3-70B-Instruct (Meta, 2024). FIG. 1, for example, shows three different LLM servers, 130a, 130b, and 130n (more or fewer LLM's can be used), that can be accessed from a terminal 132 at which the training dataset may be assembled (the terminal 132 can be local or remote to the LLM system 110).

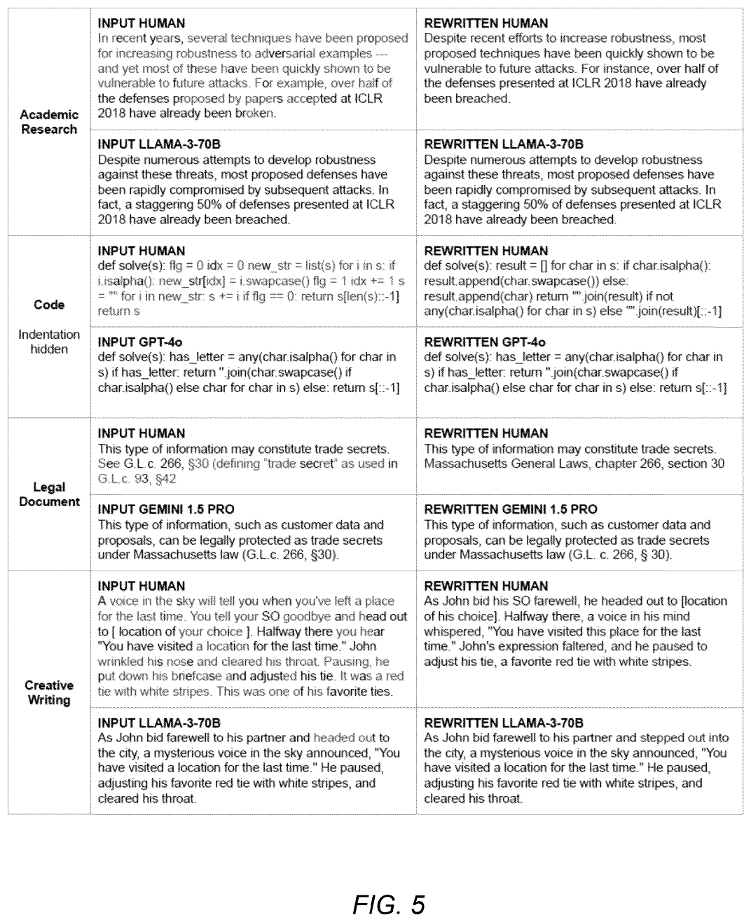

The dataset collection included 600 paragraphs per domain. Examples of human-generated content excerpts and their AI-generated counterparts are shown in FIG. 5. Similar to the examples shown in FIG. 3, the examples of texts of FIG. 5 include, at the left column, human-generated excerpts and their machine-generated counterpart (with the specific LLM system used to generate the AI-counterpart indicated), as well as the L2R-trained rewritten output produced in response to each of the left column excerpts. Here too, the darker text of the excerpts in the left column corresponds to text that was kept after the rewriting operations, while the fainter text indicates content that was deleted by the L2R rewriting LLM system. The dark text appearing in the excerpts on the right column of FIG. 5 corresponds to non-replaced content from the original input excerpts, while the fainter text corresponds to the new, inserted content, not appearing in the input excerpt. The examples of FIG. 5 demonstrate the diverse domains and source LLMs available to construct the training dataset, as well as L2R's ability in separating human and LLM texts via rewriting.

Once the training is completed (intermittent training updates can be run at regular or irregular time periods during runtime, or when the system is offline), the system 100 operates in runtime mode, during which an input record, Xᵣᵤₙₜᵢₘₑ, is provided to the system 110 (via the terminal 132) without the record being also provided to the fine-tuning controller 120. The now optimized rewrite detection system 110 (optimized using the initial training dataset described above) performs a rewrite operation on Xᵣᵤₙₜᵢₘₑ to produce a rewritten output that is provided to the edit distance evaluator 114 to compute the edit distance between the input record Xᵣᵤₙₜᵢₘₑ and the rewritten output. The classifier 116 (which may be part of the edit distance evaluator 116) determines, based on the computed edit distance (e.g., using a threshold), whether the input record Xᵣᵤₙₜᵢₘₑ was likely human-generated or machine-generated.

In some embodiments, the machine-generated content can become equivariant after being transformed by the same or a different machine learning system. Equivariance means that, when the input x is transformed (to produce transformed data x′), a rewriting is performed on the transformed data x′, and the transformation is undone (e.g., an inverse transformation operation is applied to the resultant rewrite output of the transformed data x′), the result of this sequence will produce the same (or substantially the same) output as that produced by directly rewriting the input x. Transformation for large language models is achieved by appending a transformation prompt T to the input x and asking/instructing the LLM to produce the transformed output. The reversal (inverse operation) of the transformation is denoted as T⁻¹, which is another prompt that produces an opposite effect as what T produces. Equivariance can be measured by the following distance:

$$L = D ( F ( {T}^{- 1} , F ( p , F ( T , x ) ) ) , F ( p , x ) ) .$$

Two examples for the equivariance transformation prompt T and T⁻¹ are the following operations:
1) T: Write this in the opposite meaning:
   T⁻¹: Write this in the opposite meaning:
2) T: Rewrite to Expand this:
   T⁻¹: Rewrite to Concise this:

By rewriting input content (e.g., paragraph or a sentence, with the opposite meaning twice generated), the content should be converted back to its original form if the original content is machine-generated content.

A procedure (algorithm) for detecting LLM generated content via output equivariance is provided below.

Procedure 2: Detecting LLM Generated
Content via Output Equivariance

| | |
|---|---|
| 1: | Input: Text input x. |
| 2: | Output: Class prediction ŷ |
| 3: | Inference: |
| 4: | for k = 1, ..., K do |
| 5: | Create transformation prompt Tₖ and inverse transformation |
| | prompt T′ₖ, create rephrase / rewrite prompt Pₖ. |
| 6: | Obtain LLM output Mₖ = F(Tₖ, x) |
| 7: | Obtain LLM output M′ₖ = F(Pₖ, Mₖ) |
| 8: | Obtain LLM output Sₖ = F(Tₖ,M′k) |
| 9: | Calculate bag-of-words edit Rₖ and the Levenshtein Score Dₖ |
| 10: | end for |
| 11: | Make final prediction via y = C([R₁, R₂, ..., R_{K}, D₁, D₂, ..., D_{K}]) |

It is to be noted that the transformation T is based on the language model prompt. Table I, below, provides an example of equivariance applied to a Yelp Review dataset. For simplicity, the identity transformation, p, is used, and “opposite meaning” as the equivariance transformation, T. The first data row in Table I uses human-generated input record, while the second data row is a AI-generated (e.g., via GPT) input. Here too, the darker text corresponds to text that has not changed between the input and inverse transformation output, while the fainter text represents the changes (deletions for the input records, additions for the output records) that the input records has undergone relative to the output. As can be seen from the output following the inverse transformation, AI-generated input data tends to be consistent to the original input after transformation and reversal.

TABLE I

| Input | T Transformed | T⁻¹ Reversal |
|---|---|---|
| [symbol] | Terrible big shop. The owner has no clue about anything and it's clear he hates his work. They don't have tires or any other parts you can find anywhere else. | [symbol] |
| [symbol] | The shop is mediocre with an ignorant and indifferent owner. They offer generic | [symbol] |
| unique tires and parts | tires and parts found | offer unique tires and parts |
| not found elsewhere. | everywhere else. | not found elsewhere. |

In various examples, a measure that can be used to determine whether an input x is machine-generated or human-written is the Output Uncertainty Measurement. It is assumed that LLM-generated text will be more stable when asked to perform and produce a rewrite multiple times, than human-written text. Therefore, the variance of the output may be used as a detection measurement. Under this approach, the prompt used is denoted as p. The kth generation results from an LLM are denoted as x′ₖ=F(p, x). Due to the randomness in language generation, x′ₖ will likely be different for each execution of the rewrite operation. The editing distance between two outputs A and B is denoted as D(A,B). The uncertainty measurement can then be defined as:

$$U = {\sum }_{i = 1}^{K - 1} {\sum }_{j = 1}^{K} D ( {x}_{i}^{′} , {x}_{j}^{′} )$$

It is noted that, in contrast to the invariance and equivariance, the above metric uses only the outputs, without needing the original input for the calculation of the output uncertainty. A procedure (algorithm) for detecting LLM generated content via output uncertainty is provided below.

Procedure 3: Detecting LLM generated
Content via Output Uncertainty

| | |
|---|---|
| 1: | Input: Text input x. |
| 2: | Output: Class prediction ŷ |
| 3: | Inference: |
| 4: | Given rephrase prompt P |
| 5: | for k = 1, ..., K do |
| 6: | Obtain LLM output Sₖ = F(P, x) |
| 7: | end for |
| 8: | for k = 1, ..., K do |
| 9: | for j = k, ..., K do |
| 10: | Calculate bag-of-words edit R_{k,j} and the Levenshtein Score D_{k,j} |
| 11: | end for |
| 12: | end for |
| 13: | Make final prediction via y = C([R_{1,2}, R_{1,3}, ..., R_{K-1,K}, D_{1,2}, D_{1,3}, ..., |
| | R_{K-1,K}]) |

Computing the rewriting change measurement/score can be done according to several schemes:
Bag-of-words edit—The change of bag-of-words is used to capture the edit distance created by LLM. For example, the number of common bags of n-words divided by the length of the input can be computed.
Levenshtein Score—As discussed earlier, Levenshtein score is a popular metric for measuring the minimum number of single-character edits, including deletion and addition, to change one string to the other. Standard dynamic programming can be used to calculate the Levenshtein distance. A higher score denotes the two strings are more similar. Levenshtein(A,B) is used to denote the edit distance between strings A and B. Let the rewriting output sₖ can be expressed as sₖ=F(pₖ, x). The editing distance between an input x and a rewrite sₖ obtained through use of a prompt k is the computed according to:

$${D}_{k} ( x , {s}_{k} ) = 1 - \frac{Levenshtein ( {s}_{k} , x )}{max ( len ( {s}_{k} ) , len ( x ) )}$$

Having computed an invariance measure, equivariance measure, an uncertainty measure, or any other type of measure/metric representative of an edit change between input content and its rewrite, a determination is made as to whether the input content is machine-generated or human-written. As noted, this determination can be made, for example, through a binary classifier that predicts the generation source of the input content. Alternatively, a thresholding function can be used to determine if the edit change between the input content and its rewrite are large enough that the input content may be deemed to have been generated by a human.

Thus, implementations of the rewrite-based detection framework described herein include system (such as the system 100 of FIG. 1) for detecting machine-generated content. The system includes an interfacing unit (such as the terminal 132) to receive written source input, and one or more computing devices implementing one or more machine learning models. The one or more computing devices are configured to generate by a machine learning system (such as the LLM model F(⋅) depicted as unit 112 of FIG. 1) configured to transform written content into resultant transformed content, one or more rewritten versions of the written source input, with the one or more rewritten versions being semantically similar to the written source input, derive one or more rewrite change measurements (e.g., by the edit distance evaluator 114 of FIG. 1), for the one or more rewritten versions, representing extent of differences between the one or more rewritten versions and the written source input, and determine likelihood (e.g., by the classifier 116) that the written source input was machine generated based at least on the derived one or more rewriting change measurements.

In various examples, the one or more computing devices configured to generate one or more rewritten versions can be configured to generate multiple rewritten versions of the written source input responsive to respective multiple prompts representative of rewriting instructions, the multiple rewritten versions resulting in increased rewritten diversity produced from the written source input. In some embodiments, the one or more computing devices configured to generate the one or more rewritten versions of the written source input may be configured to apply, using the machine learning system, a semantic transformation to the written source input to generate semantically transformed content, rewrite the semantically transformed content, by the machine learning system, to generate rewritten semantically transformed content, and apply to the rewritten semantically transformed content, using a machine learning system implementing an inverse semantic transformation model configured to produce an inverse semantic transformation of the semantic transformation to produce a corresponding rewritten version for the written source input. In some examples, the one or more computing devices configured to derive the one or more rewriting change measurements may be configured to derive one or more of a bag-of-words edit score and/or a Levenshtein score.

During training time, the one or more computing devices may be further configured to optimize to rewrite human-written input content with more edits than for a machine-generated input content based on a training dataset that includes multiple human-generated content records drawn from one or more data repositories comprising content from a plurality of subject matter domains, respective counterpart machine-generated content records, semantically equivalent to the multiple human-generated content records, produced by one or more other, different, LLM systems, and respective prompts selected at random, for each respective human-generated content record (and generally for its machine-generated counterpart), from a data repository of a plurality of prompts. In such embodiments, the one or more computing devices configured to optimize to rewrite human-written input content with more edits than for the machine-generated input may be configured to minimize cross-entropy loss assigned to each training dataset record, with the cross-entropy loss representing edit distance between each content record and a corresponding rewritten output produced for the each content record, with the one or more computing devices configured to minimize the cross-entropy loss being configured to perform a calibration loss process that imposes a threshold value t on an absolute value of the loss on each given input record.

The proposed rewrite-based detection system enjoys several advantages. First, since only the discrete token output is accessed from the LLM, the framework requires minimal access to the LLM models. Given that the major state-of-the-art LLM models, like GPT-3.5-turbo and GPT-4 from OpenAI, are black-box models and only provide API for accessing the discrete tokens rather than the probabilistic values, the proposed framework is general and compatible with them. Second, since the representation is discrete, it is more robust in the sense that it will be invariant to the perturbations and shifting in the input space. Lastly, symbolic representations allow the framework to construct measurements that are not differentiable, which introduces extra burden and cost for gradient-based adversarial attempts to bypass the proposed detection model.

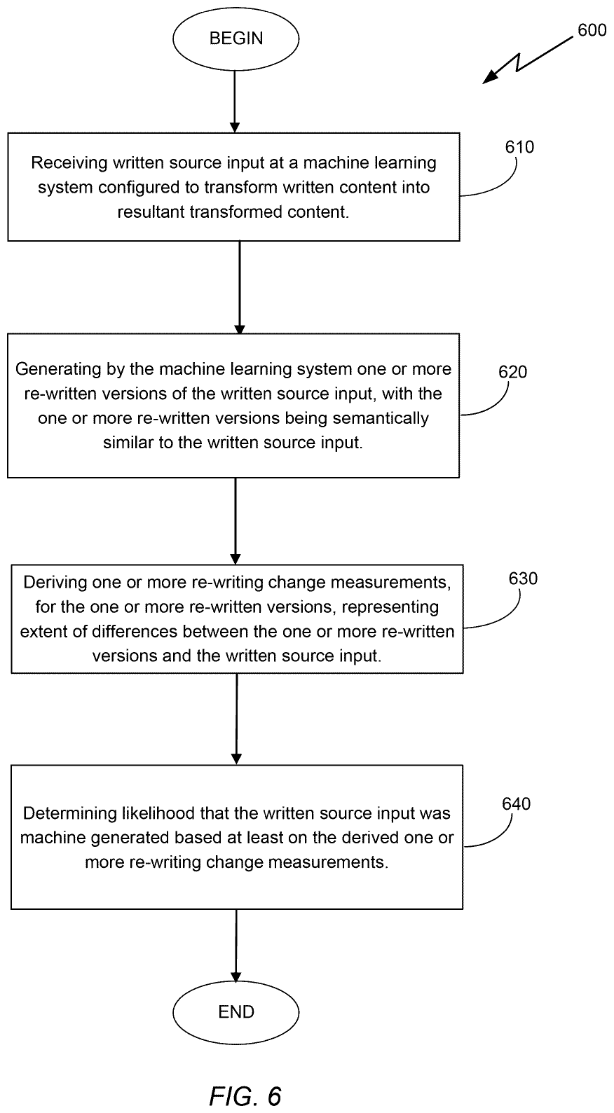

With reference to FIG. 6, a flowchart of a procedure 600 (generally performed during runtime) for detecting machine-generated content is disclosed. The procedure 600 includes receiving 610 written source input at a machine learning system configured to transform written content into resultant transformed content, and generating 620, by the machine learning system, one or more rewritten versions of the written source input, with the one or more rewritten versions being semantically similar to the written source input. In various examples, generating by the machine learning system the one or more rewritten versions of the written source input can include generating the one or more rewritten versions by the machine learning system implementing a large language model (LLM) in response to one or more requests, received by the machine learning system, with each of the one or more requests comprising a rewriting prompt and the written source input. Generating the one or more rewritten versions of the written source input may include generating respective edited content for corresponding ones of the one or more rewritten versions, with the respective edited content being representative of content differences between the one or more rewritten versions and the written source input. In some embodiments, generating by the machine learning system the one or more rewritten versions of the written source input may include generating multiple rewritten versions of the written source input responsive to respective multiple prompts representative of rewriting instructions, the multiple rewritten versions resulting in increased rewritten diversity produced from the written source input. Generating by the machine learning system one or more rewritten versions of the written source input can include applying, using a machine learning system, a semantic transformation to the written source input to generate semantically transformed content, rewriting the semantically transformed content, by the machine learning system, to generate rewritten semantically transformed content, and applying to the rewritten semantically transformed content, using a machine learning system implementing an inverse semantic transformation model, an inverse semantic transformation of the semantic transformation to produce a corresponding rewritten version for the written source input. In some examples, deriving the one or more rewriting change measurements may include generating an iterative rewritten version based on one of the one or more rewritten versions of the written source input, and computing an edit distance between the one of the one or more rewritten versions and the iterative rewritten version.

With continued reference to FIG. 6, the procedure 600 further includes deriving 630 one or more rewriting change measurements, for the one or more rewritten versions, representing extent of differences between the one or more rewritten versions and the written source input. In various embodiments, deriving the one or more rewriting change measurements can include deriving one or more of, for example, a bag-of-words edit score and/or a Levenshtein score.

The procedure 600 additionally includes determining 640 likelihood that the written source input was machine generated based at least on the derived one or more rewriting change measurements. Determining the likelihood that the written source input was machine generated may include one or more of, for example, comparing the one or more rewriting change measurements to respective one or more pre-determined threshold values and/or analyzing at least the rewriting change measurement with a trained machine learning linear readout model configured to predict likelihood that the written source was machine generated.

In some embodiments, the machine learning system can be configured to rewrite human-written input content with a lower degree of invariance than for a rewrite machine-generated input content. The machine learning system may be optimized to rewrite human-written input content with more edits than for a machine-generated input content based on a training dataset that includes multiple human-generated content records drawn from one or more data repositories with content covering a plurality of subject matter domains, respective counterpart machine-generated content records, semantically equivalent to the multiple human-generated content records, produced by one or more other, different, LLM systems, and respective prompts selected at random, for each respective human-generated content record (and generally for its machine-generated counterpart), from a data repository of a plurality of prompts. The machine learning system may be optimized based on minimizing cross-entropy loss assigned to each training dataset record, with the cross-entropy loss representing edit distance between each content record and a corresponding rewritten output produced for the each content record. Minimizing of the cross-entropy loss can include performing a calibration loss imposing a threshold value t on an absolute value of the loss on each given input record.

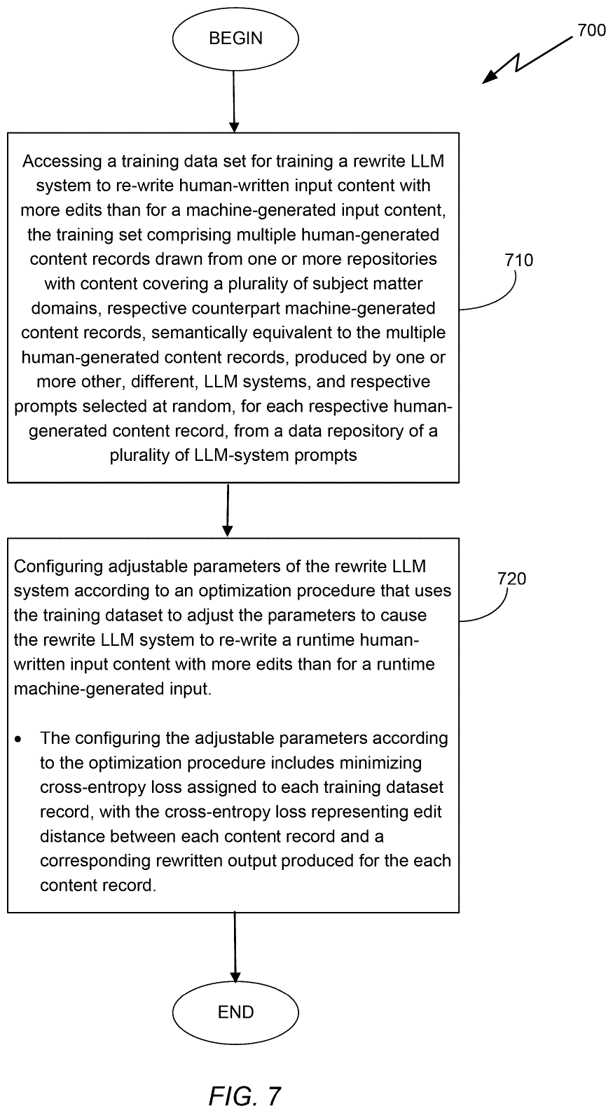

With reference next to FIG. 7, a flowchart of another procedure 700 (typically performed during training time, but intermittently also performed when updates are needed or are scheduled to be performed during runtime or when the system is offline) for optimizing a detection system for detecting machine-generated content is shown. The procedure 700 includes accessing 710 a training data set for training a rewrite LLM system to rewrite human-written input content with more edits than for a machine-generated input content. The training set includes multiple human-generated content records drawn from one or more repositories with content covering a plurality of subject matter domains, respective counterpart machine-generated content records, semantically equivalent to the multiple human-generated content records, produced by one or more other, different, LLM systems, and respective prompts selected at random, for each respective human-generated content record (and generally for its machine-generated counterpart), from a data repository of a plurality of LLM-system prompts.

The procedure 700 further includes configuring 720 adjustable parameters of the rewrite LLM system according to an optimization procedure that uses the training dataset to adjust the parameters to cause the rewrite LLM system to rewrite a human-written input content with more edits than for a machine-generated input. Configuring the adjustable parameters according to the optimization procedure includes minimizing cross-entropy loss assigned to each training dataset record, with the cross-entropy loss representing edit distance between each content record and a corresponding rewritten output produced for the each content record.

In various examples, minimizing the cross-entropy loss can include performing a calibration loss process that imposes a threshold value t on an absolute value of the loss on each given input record. In some examples, the procedure 700 further includes substituting, for one of the counterpart machine-generated content records, one or more words of the one of the counterpart machine-generated content records with one or more substitute words determined by an auxiliary LLM system, wherein the one or more substitute words maintain part-of-speech consistency and minimally increase perplexity as that of the respective one or more words of the one of the counterpart machine-generated content records. In various embodiments, deriving the one or more rewriting change measurements may include deriving the edit distance between the each content record and the corresponding rewritten output is computed according to one or more of, for example, a bag-of-words edit score and/or a Levenshtein score.

Testing and evaluation was conducted on the rewrite detection frameworks and the training/optimization approaches described herein. In a first set of experiments, the performance of the rewrite detection framework that was not fine-tuned according to the approaches described herein was evaluated. For the experiments conducted, GPT-3.5-Turbo was used as the LLM engine to rewrite the input text. Once the editing distance feature was computed based on the rewritten output and the original input data, Logistic Regression or XGBoost were used to perform the binary classification. When compared to the Ghostbuster detection system (a classifier for machine generated text detection that uses probabilistic output from large language models as features, and performs feature selection to train an optimal classifier), the proposed rewrite detection framework outperformed the Ghostbuster system by up to 29 points. In another experiment, the detection classifier of the proposed framework was trained on one dataset and evaluated on the other. For and out-of-distribution (OOD) experiment, the proposed rewrite detection framework improved by up to 32 points over the Ghostbuster methodology, demonstrating the effectiveness of the proposed rewrite-detection approach over prior methods.

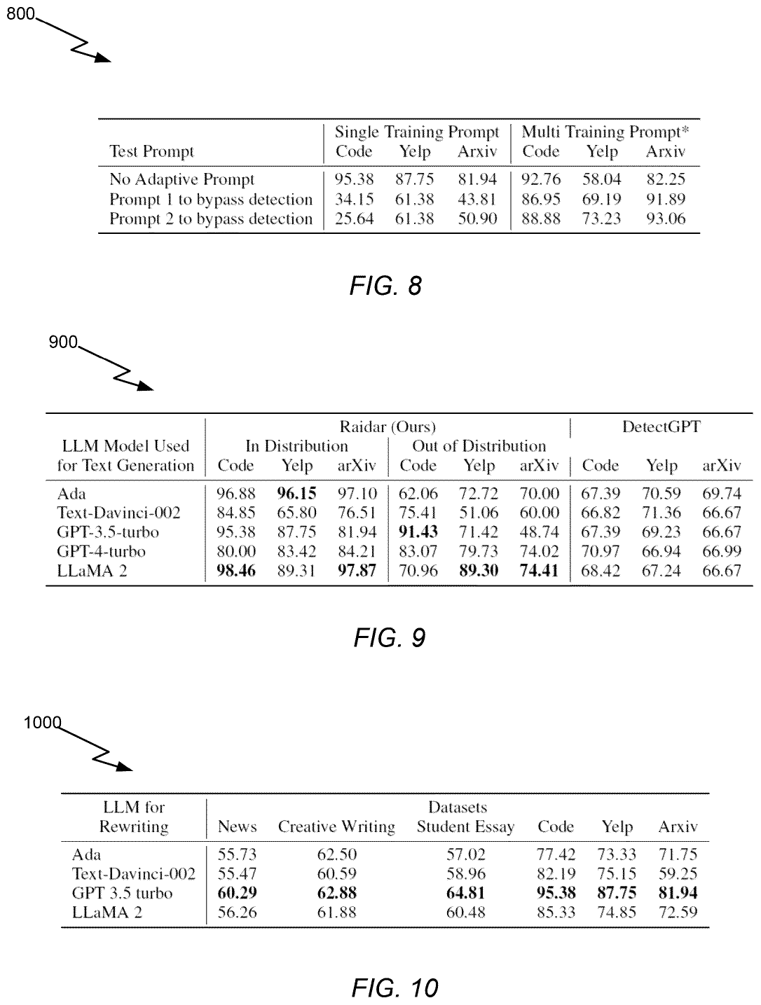

The first set of experiments also included an evaluation of the detection robustness against rephrased text generation to evade detection. The proposed rewrite detection framework can detect GPT text effectively when they are not adversarially rephrased. However, a sophisticated adversary might craft prompts for GPT such that the resulting text, when rewritten, undergoes significant changes, thereby evading detection. Consider the following prompts to modify the GPT input: a) “Help me rephrase it in human style,” and b) “Help me rephrase it, so that another GPT rewriting will cause a lot of modifications.” Table 800 of FIG. 8 provides performance results under adaptive prompts aiming to evade the rewrite-based detector. In the “Single Training Prompt” column, the detector was trained on a non-adaptive prompt and tested against both the same prompt and two evasive prompts. As can be seen, adversarial rephrasing can bypass the proposed rewrite-based detection system. However, in the “Multi Training Prompt” column, the model is trained using two prompts and tested on a third, different prompt. The last two rows shows results under adaptive prompts to evade detection by the proposed rewrite-based detection framework. Training on multiple prompts enhances the proposed rewrite-based detection system's robustness against machine-generated inputs attempting evasion. Table 800 reveals that while the proposed rewrite-based detection system, trained on the default single prompt data, can be bypassed by adversarial rephrasing, when trained on two of the prompts and tested on the remaining prompts the proposed framework performs well against adversarial prompts. Even when tested against unseen adversarial prompts, the proposed framework still identified machine-generated content designed to elude it, achieving up to 93 points on F1 score. One exception is on the Yelp dataset; the “no adaptive prompt” has lower performance on “multiple training prompts” than “single training prompts.” This is possibly due to the fact that the Yelp dataset introduces a larger data difference when prompted differently, and thus “multiple training prompts” setup will decrease performance due to training and testing on different prompts. In general, results listed in table 800 demonstrate that with proper training, the proposed framework can remain robust under rephrased text intended to evade detection, underscoring the significance of diversifying prompt types when training the rewrite-based detection system.

Next, the first set of experiments further included an evaluation of the effect of the source of generated data on the performance of the proposed framework. Generally, the detection framework was trained on text generated from GPT-3.5. An evaluation was conducted to determine if the detection model of the proposed framework can still detect machine-generated text when they are generated from a different language model. Table 900 of FIG. 9 provides performance data showing robustness in detecting outputs from various language models. Using the same GPT-3.5-Turbo rewriting model, table 900 lists F1 detection scores for detecting text from five generation models across three diverse tasks. In the in-distribution experiment, detectors were trained and tested on the same LLM model. For out-of-distribution, detectors were trained on text from other generators. Overall, the proposed framework effectively detects machine-generated text in both scenarios. Despite the fact that all rewrites were performed by GPT-3.5, up to a 96 F1 score points was achieved. Notably, a GPT-3.5-based rewrite engine excels at detecting Ada-generated content, indicating the proposed framework's versatility in identifying both low (Ada) and high-quality (GPT-3.5) data, even when they are generated from a different model.

The detection efficiency was also evaluated on the Claude generated text on student essay, where the proposed framework achieved an F1 score of 57.80. In the out-of-distribution experiment, the detection framework was trained on data from two language models, and tested on data generated by a third model. Despite a performance drop on detecting the out-of-distribution test data generated from the third model, the detection framework remained effective in detecting content from this unseen model, underscoring the robustness of the proposed framework and adaptability, with up to 91 points on F1 score.

Next, an evaluation was performed to determine how the type of detection model and the model size affect performance in perturbation-based detection methods. Given the same input text generated from GPT-3.5, the proposed approach's efficacy was explored with alternative rewriting models with different size. In addition to using the costly GPT-3.5 to rewrite, two other smaller models, Ada and Text-Davinci-002, were used, and their detection performance when they were used to perform rewrite operations was evaluated. Table 1000 of FIG. 10 includes performance data relating to the effectiveness of detection using various large language models for rewriting. Specifically, the data presented includes detection F1 scores for the same input data rewritten by Ada, Text-Davinci-002, and GPT-3.5. Among these, GPT-3.5-turbo yielded the highest performance in rewriting for detection.

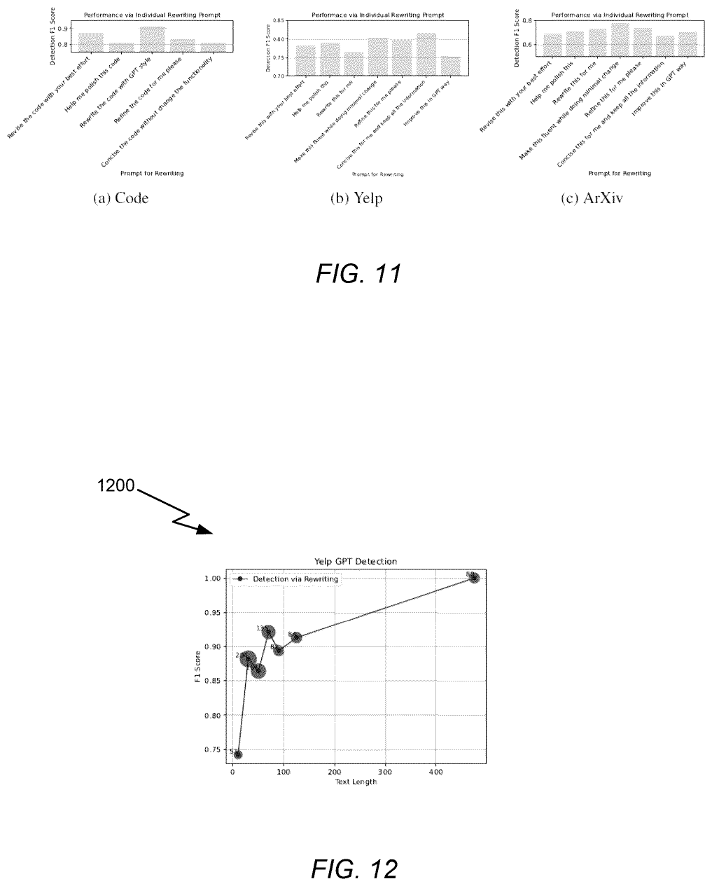

Another evaluation performed as part of the first set of experiments was to assess the impact of using different prompts. FIG. 11 includes graphs showing the detection F1 scores for various prompts across three datasets. Different prompts used during rewriting can have a significant impact on the final detection performance. There is no single prompt that performs best across all data sources. With a single rewriting prompt, up to 90 points of detection F1 score can be obtained. It is noted that the proposed approach can achieve high detection performance using just a single rewriting prompt.

Lastly, an evaluation of the impact of content length was performed. The detection framework's performance across varying input lengths using the Yelp Review dataset was assessed. FIG. 12 includes a graph 1200 illustrating the detection performance as input length increases. Longer inputs, in general, achieve higher detection performance. Notably, while many algorithms fail with shorter inputs, the proposed detection framework described herein can achieve 74 points of detection F1 score even with inputs as brief as ten words, highlighting the effectiveness of the proposed approach.

In a second set of experiments, the use of fine-tuning to configure the rewrite detection frameworks was evaluated. Testing and evaluation of the proposed framework was performed on one NVIDIA A100 GPU with 40 GB VRAM. The evaluation used ‘meta-Llama/Meta-Llama-3-8B-Instruct’ (AI@Meta, 2024) as the open-sourced rewrite model in all experiments. To fine-tune Llama with 8B parameters, a 4-bit QLORA was employed, with r set to 16, lora_alpha set to 32, and lora_dropout set to 0.05. An initial learning rate of 5e-6 was used, and the training continued until convergence. 70% of the dataset compiled was used for training (if applicable) and the rest for testing in all experiments. Rewriting on a single domain costs around two hours on a single GPU.

The baseline classifiers (to determine if the source content was human-generated or machine-generated), against which the proposed rewrite-based detection framework was compared, included a GPT-2 Detector, a Fast-DetectGPT, and RAIDAR 2024). For RAIDAR (the detection method when not trained to incorporate additional information about LLM-generated content), the experiments included the use of a close-sourced model, namely, Gemini 1.5 Pro, as the rewrite model.

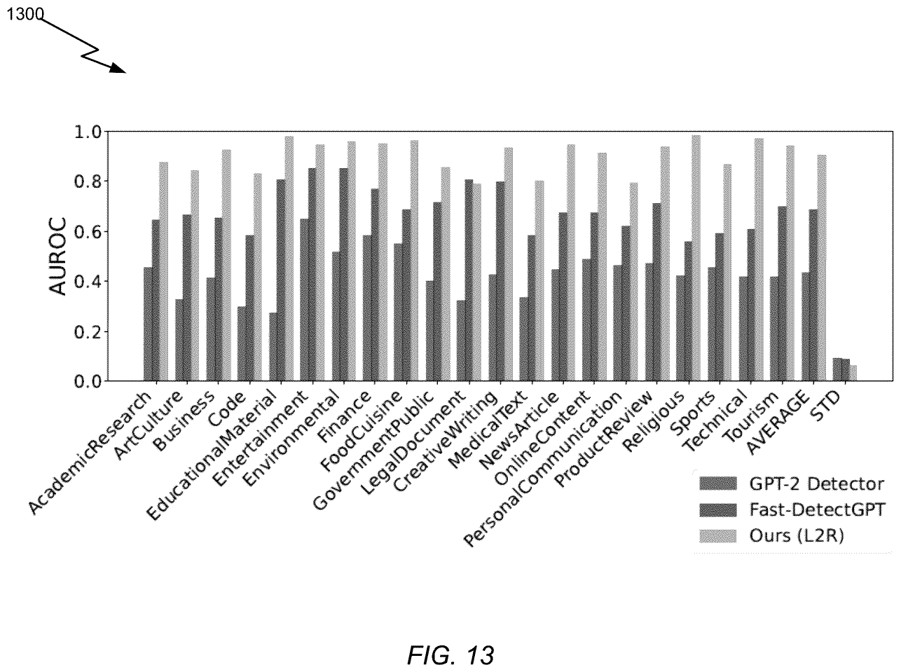

The second set of experiments included an evaluation to compare the performance of the L2R-based detection framework (as described herein) with the performance of other classifiers (detection frameworks). More particularly, the performance of the L2R-based approach to optimize the detection framework was compared with Fast-DetectGPT and GPT-2 Detector, with the performance measured by the Area Under the Receiver Operating Characteristic Curve (AUROC) scores (the metric used in Fast-DetectGPT). The result for each domain (from the universal dataset described above) is provided in the graph 1300 of FIG. 13. As can be seen, the L2R-based detector and Fast-DetectGPT constantly outperform GPT-2 Detector among all domains. Additionally, the L2R-trained detector outperforms Fast-DetectGPT in 20 of 21 domains, by an average of 20.6% in AUROC among all domains. The L2R-trained framework has a lower AUROC score than Fast-DetectGPT, by 2.0%, on the LegalDocument domain, which might be because legal documents require more rigorous writing style than the other domains, which leaves less room for rewriting, even for human writers.

In general, the fluctuating AUROC scores indicate the challenging nature of compiling a comprehensive dataset with records from different domains with independent distribution to train a L2R-trained detector with robust performance. The performance results of FIG. 13 also show that an L2R-based framework has better knowledge of the intricate differences between human-generated and AI-generated texts in various domains and is more capable in the real-world setting.

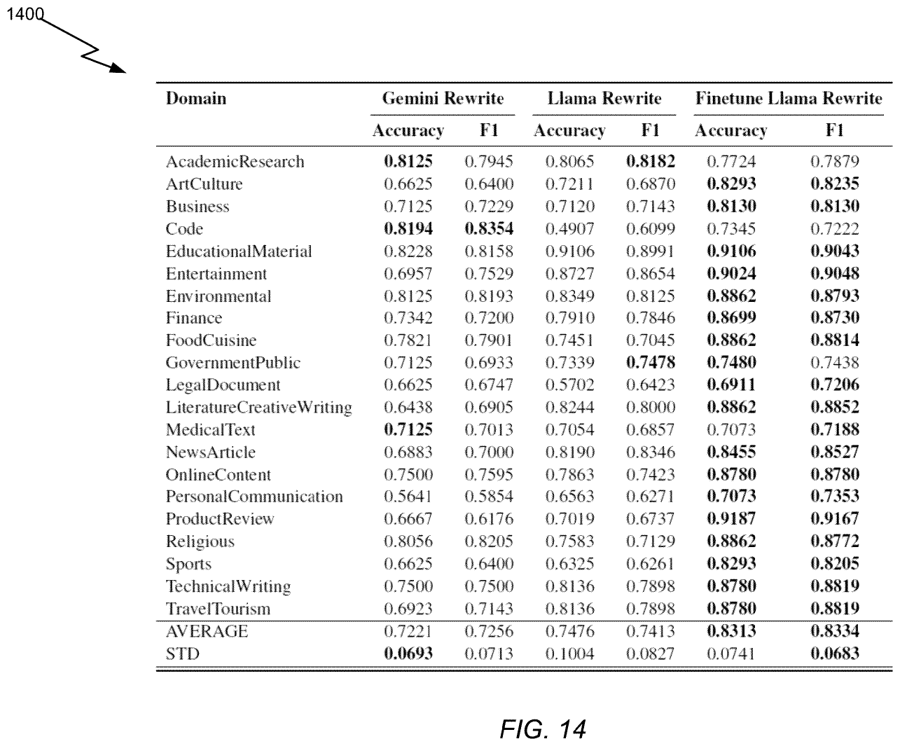

Another evaluation performed as part of the second set of experiments was to determine how the rewrite functionality of the L2R detection framework (i.e., where the rewrite was trained to edit human-generated text more extensively than machine-generated texts) compared with simple rewrite engines. In this part of the evaluation, the L2R-based framework was compared with RAIDAR (whose rewrite model is not fine-tuned), using accuracy and F1 scores. The results for each independent domain, along with their average and standard deviation, are provided in table 1400 of FIG. 14, which provides a comparison of detection performance measured in accuracy and F1 score for the Gemini rewrite system, the Llama rewrite system, and the L2R-optimized rewrite system. Since RAIDAR does not fine-tune its rewrite model, it has the advantage of using closed-sourced models, i.e., Gemini, that are more capable on different tasks. However, both average accuracy and F1 scores are higher when using Llama-3 for rewrite which indicates that the capability in generation does not correlate to the capability in LLM-generated text detection. On the other hand, L2R-based detection frameworks outperform RAIDAR on average accuracy by 8.4% and F1 score by 9.2% while maintaining the lowest standard deviation, which demonstrates the benefit of fine-tuning.

A third evaluation that was performed as part of the second set of experiments was to determine the effectiveness of using a diverse prompt set in data preparation. As noted, the diverse dataset that was prepared used 21 independent domains, 200 different prompts, and three different LLMs sources (engines) to compile the training data for the fine-tuning of the L2R-based detection framework. Such a diverse dataset resembles real-world use cases for generated text detectors better than the traditional evaluation datasets which are usually constrained to one single domain and generation prompt. To show the superiority of the universal dataset described herein to train more capable detection models, another companion nondiverse dataset was created for the same 21 domains and three source LLMs, but in which AI data was generated only with one prompt, namely, the prompt “rewrite this for me please:”

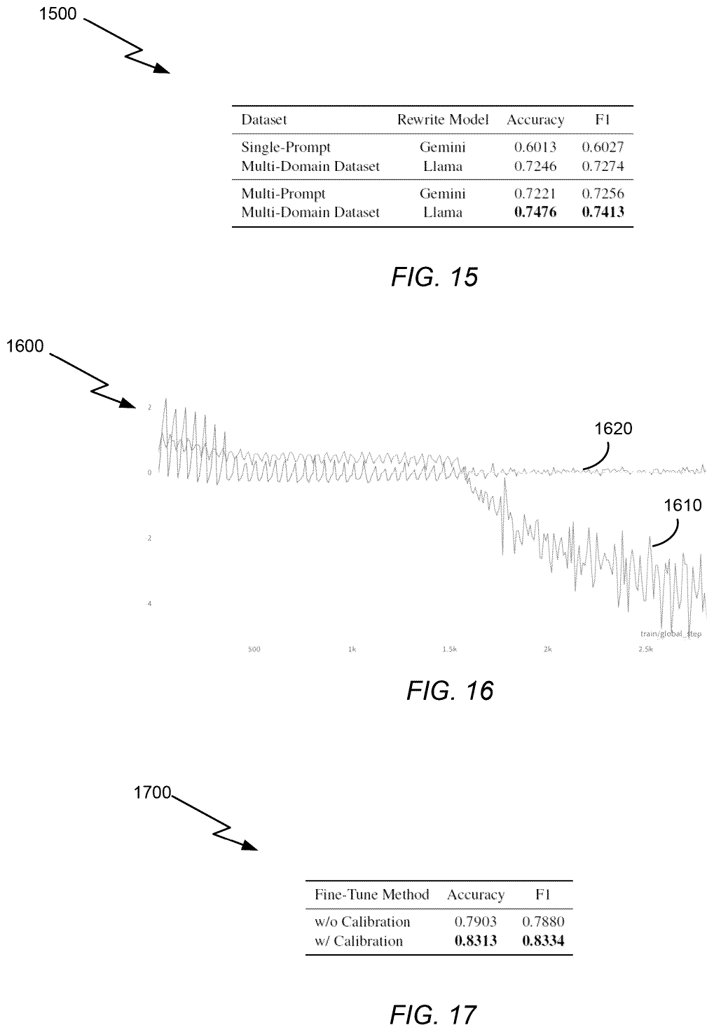

Having prepared the companion nondiverse training dataset, a detection system was trained without fine-tuning, on the non-diverse dataset, and then evaluated on the diverse dataset. With reference to FIG. 15, table 1500 provides a comparison of accuracy and F1 scores for different rewrite models on the nondiverse and diverse datasets. As shown in table 1500, the use of diverse prompts in the training set yields to 12.3% increase in F1 score for Gemini 1.5 Pro rewrite model, and 1.4% increase in F1 score for the Llama-3 8B rewrite model. This validates the effectiveness of using a diverse prompts set, and suggests that such diversity could help the detector to capture more information about real-world data distributions. When combining with the fine-tuning framework, the average F1 score is increased by 10.6%.

A fourth evaluation was to determine the effectiveness of the calibration loss during fine-tuning. As discussed above, another important contribution that improves the fine-tuning performance is the calibration loss. As noted, without this loss, the model tends to over-fit during fine-tuning. With reference to FIG. 16, a graph 1600 that includes training loss curves for the rewrite model is shown. In FIG. 16, curve 1610 plots the loss curve without the calibration loss method, while curve 1620 plots the loss for the rewrite model when trained with the calibration loss method. As shown, when the calibration loss method is used, the loss curve 1620 exhibits faster convergence and higher stability than when the calibration loss method is not used (corresponding to the curve 1610). Indeed, as illustrated by the curve 1610, the model loss drastically decreases after 1500 steps, resulting in verbose rewrites even for LLM-generated text.

An ablation study was conducted on five domains where the detection accuracy and Fl score were only 0.62 and 0.54, respectively, after the model over-fits. It was hypothesized that this technique could benefit model learning because the threshold effectively prevents further modification to model weights once an input, labeled either as machine (AI)-generated or human-generated, falls in its respectively distribution. Since the purpose is simply to draw a boundary rather than separate the distributions, this halt in further weight adjustments facilitates the model to only care about those inputs which are not yet correctly classified, so that it could converge more efficiently and effectively. FIG. 17 includes table 1700, which provides a comparison of accuracy and F1 scores for fine-tuning Llama rewrite system with and without the calibration method. The table 1700 shows that using the calibration loss method when training the model allows our the fine-tuning training procedure to focus on learning the hard samples, which significantly improves the detection. Indeed, applying the calibration loss method during training of the L2R-based system improves detection performance among the 21 domains of the universal training dataset, even when compared with a model tuned without the loss before overfitting begins.

Thus, implementing the rewrite-based detection system according to L2R model (i.e., training the rewrite system to produce significant rewrite edits for human-generated content, and few (or no) edits for machine-generated content) enhances the detection of machine-generated text by learning to rewrite (during runtime) less for machine-generated inputs and more for human-generated inputs. The L2R methodology excels in identifying machine-generated content across various models and diverse domains. Detection frameworks trained and implemented according to the L2R methodology surpass the performance of existing detection methods in accuracy. As the quality of machine-generated (e.g., LLM-generated) content continues to improve, it is expected that the L2R-trained detection frameworks will similarly advance in its detection accuracy.

In a third set of experiments, the effectiveness of the proposed rewrite-based detection system in the face of an adversarial rewrite attack was explored. To that end, an attack implementation called RAFT (Realistic Attacks to Fool Text Detectors), which is a grammar error-free black-box attack against existing LLM detectors, was developed. In contrast to previous attacks for language models, the RAFT attack exploits the transferability of LLM embeddings at the word level while preserving the original text quality. RAFT leverages an auxiliary LLM embedding to optimally select words in machine-generated text for substitution by performing a proxy task. It then employs a black-box LLM to generate replacement candidates, greedily selecting the one that most effectively subverts the target detector. RAFT only requires access to an LLM's embedding layer, making it easily deployable and adaptable with the numerous powerful open-source LLMs available.

Given a text passage X comprising N words [x₁, . . . , x_{N}], consider a black-box detector D(X)∈[0, 1] that predicts whether the input X is machine-generated or human-written. A higher D(X) score indicates a greater likelihood that X is machine-generated. Denote t as the detection threshold, such that X is classified as machine-generated if D(X)≥τ. The goal for an adversarial attack on an LLM rewrite detector is to perturb the input passage X into X′ such that D(X′) incorrectly classifies X′ as human written, while ensuring that X′ remains indistinguishable from human-written text when manually reviewed. To preserve semantic similarity between X and X′, the number of words to be substituted is constrained to k % of X. Additionally, to maintain grammatical correctness and fluency, x; and x′; must have a consistent part-of-speech. The attack on the LLM Detector D can be formulated as a constrained minimization problem, with the objective to modify X such that D(X′)≤τ:

$$\begin{matrix}{X ’ = arg {min}_{{x}^{′}} D ( X ’ ) s . t . pos ( x ’}_{i} ) = pos ( xi ) , \\ {x ’}_{i} ∈ \{ {x}_{i} \} ⋃ s ( {x}_{i} , X , t ) , \\ {\sum }_{i}^{N} 1 ( {x}_{i}^{′} \neq {x}_{i} ) \leq kN\end{matrix}$$

where pos(xᵢ) returns the part-of-speech label of any word x; and s(⋅) is a word substitution generator that outputs t candidates for xᵢ using the surrounding context in X.

The proposed attack process is based on finding important words for substitution using a proxy task embedding objective. This attack process leverages the observations that LLM's share similar latent semantic spaces and perform similarly on semantic tasks. To effectively minimize D(X′), a white-box LLM M is used to perform a word-level task F that generates a score fᵢ for each word that acts as a proxy signal for selecting words to replace, where M does not necessarily need to be the same source LLM model used to generate X. LLM embedding tasks that correlate with identifying words that would alter the statistical properties of the machine-generated text, such as next-token generation and supervised LLM text detection, can be chosen. A subset of words in the rewritten content to select for substitution is determined according to Xk=argmax_{kN}F(M,X), where Xₖ is the subset of k % words in X to perturb from.

To perturb words in Xₖ while ensuring that X remains indistinguishable to a human evaluator as machine-generated, the replacement words are constrained such that they must not induce grammatical errors and are semantically consistent with the original text. An LLM model such as GPT-3.5-Turbo (OpenAI, 2024b) may be used as the word substitution candidate generator (it is noted that other LLM models may also be used as the candidate generator) by prompting it with the word to replace and its surrounding context, e.g., using the following example prompt:
“Q: Given some input paragraph, we have highlighted a word using brackets. List top {t} alternative words for it that ensure grammar correctness and semantic fluency. Output words only. \n {paragraph}
A: The alternative words are 1 . . . , 2 . . . ”

Using an LLM for word substitution allows to conveniently obtain context-compatible candidates in one step, instead of needing to compute candidates using word embeddings followed by an additional model to check context compatibility. After retrieving t replacement candidates from GPT-3.5-Turbo (or some other LLM system/model), words that have inconsistent part-of-speech with the original word are filtered out by using the NLTK library, and then the candidate that minimizes D is selected.

In implementing the attack scheme proposed herein, k was set to 10% across all experiments to evaluate the effectiveness of the attack with a limited number of changes. The effectiveness is evaluated using language modeling heads for next-token generation and supervised LLM detection tasks as proxy scoring models to optimally select words to substitute in X. For next-token generation, the probability of the next token being Xᵢ from the language modeling head is used as the proxy objective. Intuitively, replacing tokens with the highest likelihood from the LLM allows altering the statistical properties of the machine-generated text most effectively. For LLM detection, the importance of each word is iteratively computed based on the decrease in detection score D(X) by assigning 0 to its corresponding tokens in the detector's attention mask, and ranking the score changes in descending order, where the word that yields a higher absolute change in detector score is considered to be more important for detection.

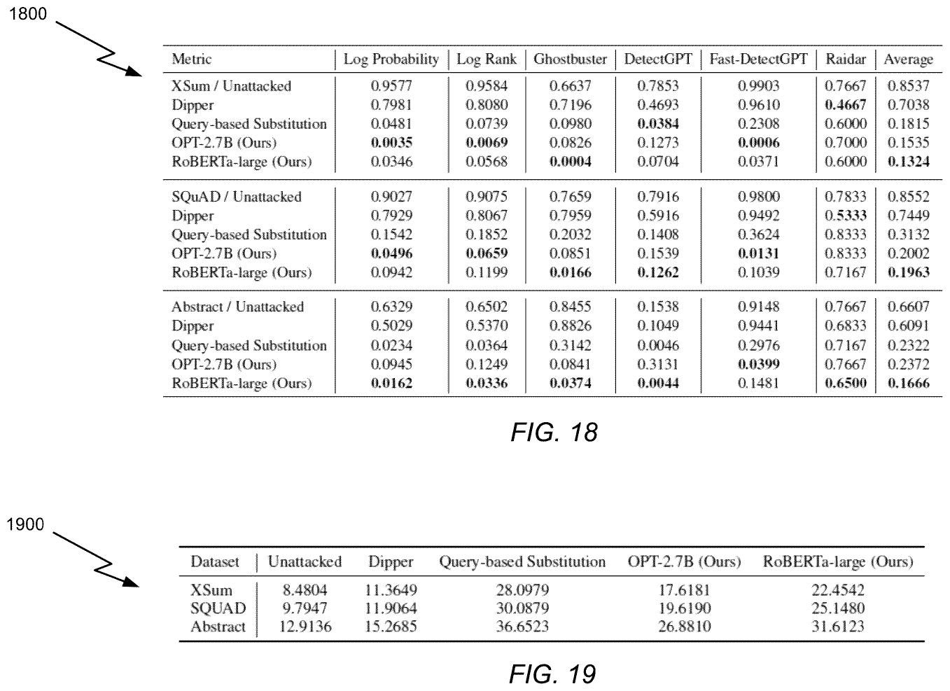

In conducting the third set of experiments three datasets were used to cover a variety of domains and use cases. 200 pairs of human-written and LLM-generated samples were used from each of the XSum and SQUAD datasets generated using GPT-3.5-turbo. Additionally, the ArXiV Paper Abstract dataset, which contains 350 abstracts generated using GPT-3.5-turbo from ICLR conference papers, was used. The Area Under the Receiver Operating Characteristic Curve (AUROC) was used as the metric to summarize detection accuracy for the attack framework under various thresholds. The True Positive Rate was also measured at a 5% False Positive Rate (TPR at 5% FPR), as it is important in this context for human-written text to not be misclassified as machine-generated text. To measure text quality, the perplexity of the attacked text against GPT-NEO-2.7B was measured. The language modeling heads of GPT-2, OPT-2.7B, GPT-NEO-2.7B, and GPTJ-6B were used for next-token generation, and the RoBERTa-base and RoBERTalarge supervised GPT-2 detector models for LLM detection as proxy tasks to rank which words from the original text to substitute. Results for OPT-2.7B and RoBERTa-large proxy scoring models are presented in table 1800 of FIG. 18. In generating the performance data for table 1800, the performance of RAFT against six (6) target detectors was evaluated using GPT-3.5-Turbo generated text from 3 datasets, measuring the detector's performance before and after attack using the AUROC metric. Bolded AUROC results indicate best attack performance. The six detectors against which the attack process was used included Log Likelihood, Log Rank, Detect GPT, Fast-DetectGPT, Ghostbusters, and the proposed rewrite-based detection framework described herein (also referred to as Raidar).

FIG. 19 includes table 1900 provides performance results corresponding to the perplexity of text after different attacks measured by GPT-NEO-2.7B. RAFT attacked texts were optimized against Fast-DetectGPT detector. Lower perplexity indicates better text quality. The results show that the RAFT attack is able to maintain text quality while subverting detection.

Tables 1800 and 1900 demonstrate that the proposed RAFT attack effectively compromises all tested detectors while causing only a modest change in perplexity from the original machine-generated text. Using next-token generation with OPT-2.7B and LLM detection with RoBERTa-large as proxy scoring models for RAFT achieved lower AUROC across all datasets and target detectors when compared to the original text, and in most cases, lower than both DIPPER and query-based word substitution attacks. Although DIPPER preserves the text quality better in terms of perplexity, its AUROC was significantly higher than RAFT attack or the query-based word substitution attack. The TPR at 5% FPR was 0 for almost all RAFT attacked text.

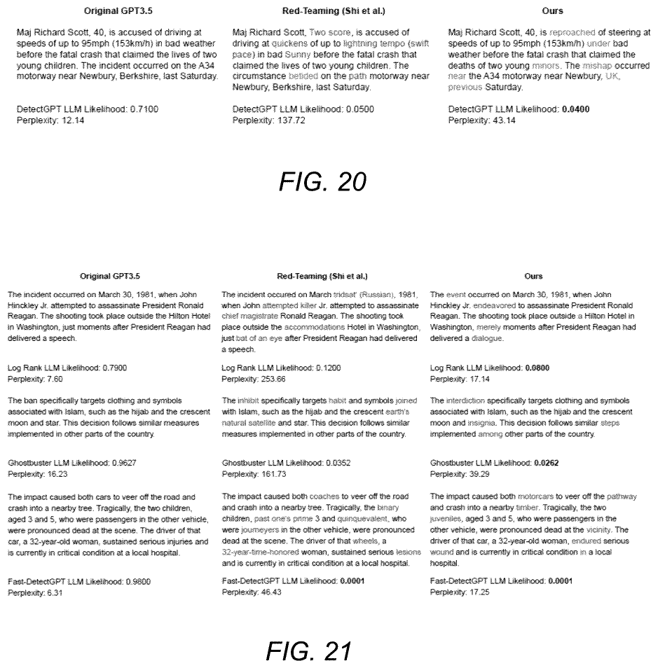

The proposed Raidar framework (i.e., the rewrite-based detection framework) stands out as the most robust detector against attacks, likely due to the unique edit distance of rewriting used in the approach. Qualitative results shown in FIGS. 20 and 21 highlight the proposed detection framework semantic consistency and language fluency. FIG. 20 shows that RAFT can attack a sample text generated by GPT-3.5-turbo more effectively to subvert detection by DetectGPT than recent red teaming attack efforts while preserving language fluency and semantic consistency. By enforcing grammatical consistency in the substituted words through POS correction, RAFT achieves significantly lower perplexity than attacks that do not enforce grammar. Qualitative evaluation also highlight RAFT's language fluency and semantic consistency with the original text. Fainter text in the text samples of FIG. 20 represent edited/modified content. In the red-teaming column, faint text corresponds to substituted words with grammatical errors or semantic inconsistencies. In the “Ours” (i.e., Raidar”) column, the edited text corresponds to error-free substitutions. FIG. 21 shows generated texts from LLMs and their respective attacks using the query-based word substitution attack and RAFT, with the RoBERTa-large proxy scoring model, evaluated against Log Rank, Ghostbuster, and Fast-DetectGPT detectors. RAFT demonstrates the greatest reduction in detection likelihood while maintaining grammatical correctness and semantic consistency with the original text. Most of the fainter text in the middle column corresponds to substituted words with grammatical errors or semantic inconsistencies. Fainter text in the right column, on the other hand, corresponds to error-free substitutions.

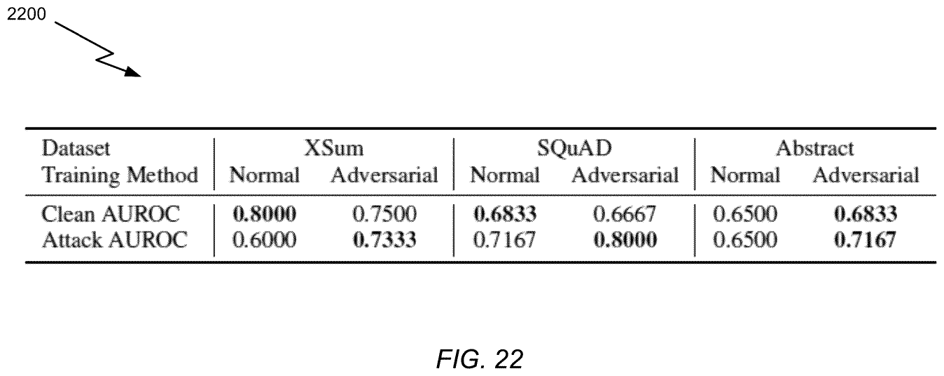

An effective attack scheme can be used to make detectors more robust through adversarial training. As shown in table 2200 of FIG. 22, after the Raidar detector undergoes adversarial training on RAFT-attacked text, it consistently demonstrates a significant increase in detection performance compared to the performance decrease observed before retraining. For the Abstract dataset, the AUROC for both attacked and non-attacked text samples increases, indicating that RAFT can enhance the robustness of existing detectors through adversarial training.

Implementing the proposed framework and performing the various techniques and operations described herein may be facilitated by a controller device(s) (e.g., a processor-based computing device). Such a controller device may include a processor-based device such as a computing device, and so forth, that typically includes a central processor unit or a processing core. The device may also include one or more dedicated learning machines (e.g., neural networks) that may be part of the CPU or processing core. In addition to the CPU, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, determining whether input content is machine-generated or human-generated, as well as to control the training and/or optimization of a rewrite-based detection implementations. The storage device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

In implementations based on learning machines, different types of learning architectures, configurations, and/or implementation approaches may be used. Examples of learning machines include neural networks, including convolutional neural network (CNN), feed-forward neural networks, recurrent neural networks (RNN), etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc. Further examples of learning architectures that may be used to implement the framework described herein include language models architectures, large language model (LLM) learning architectures, auto-regressive learning approaches, etc. In some embodiments, encoder-only architectures, decoder-only architectures, encoder-decoder architecture may also be used in implementations of the framework described herein.

The neural networks (and other network configurations and implementations for realizing the various procedures and operations described herein) can be implemented on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's, which can be programmed according to, for example, a CUDA C platform), and may also include special purpose logic circuitry, e.g., an FPGA (field programmable gate array), an ASIC (application-specific integrated circuit), a DSP processor, an accelerated processing unit (APU), an application processor, customized dedicated circuitry, etc., to implement, at least in part, the processes and functionality for the neural network, processes, and methods described herein. The computing platforms used to implement the neural networks typically also include memory for storing data and software instructions for executing programmed functionality within the device. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc.

The various learning processes implemented through use of the machine-learning architectures described herein may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, PyTorch, JAX, and other popular machine learning frameworks.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The presently disclosed subject matter is further described in the materials of Attachment A appended hereto. Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method for detecting machine-generated content, the method comprising:
receiving written source input at a machine learning system configured to transform written content into resultant transformed content;
generating by the machine learning system one or more rewritten versions of the written source input, with the one or more rewritten versions being semantically similar to the written source input;
deriving one or more rewriting change measurements, for the one or more rewritten versions, representing extent of differences between the one or more rewritten versions and the written source input; and
determining likelihood that the written source input was machine generated based at least on the derived one or more rewriting change measurements.

2. The method of claim 1, wherein determining the likelihood that the written source input was machine generated comprises one or more of:
comparing the one or more rewriting change measurements to respective one or more pre-determined threshold values; or
analyzing at least the rewriting change measurement with a trained machine learning linear readout model configured to predict likelihood that the written source was machine generated.

3. The method of claim 1, wherein generating by the machine learning system the one or more rewritten versions of the written source input comprises:
generating the one or more rewritten versions by the machine learning system implementing a large language model (LLM) in response to one or more requests, received by the machine learning system, each of the one or more requests comprising a rewriting prompt and the written source input.

4. The method of claim 1, wherein generating the one or more rewritten versions of the written source input comprises:
generating respective edited content for corresponding ones of the one or more rewritten versions, the respective edited content representative of content differences between the one or more rewritten versions and the written source input.

5. The method of claim 1, generating by the machine learning system one or more rewritten versions of the written source input comprises:
generating multiple rewritten versions of the written source input responsive to respective multiple prompts representative of rewriting instructions, the multiple rewritten versions resulting in increased rewritten diversity produced from the written source input.

6. The method of claim 1, wherein generating by the machine learning system one or more rewritten versions of the written source input comprises:
applying, using a machine learning system, a semantic transformation to the written source input to generate semantically transformed content;
rewriting the semantically transformed content, by the machine learning system, to generate rewritten semantically transformed content; and
applying to the rewritten semantically transformed content, using a machine learning system implementing an inverse semantic transformation model, an inverse semantic transformation of the semantic transformation to produce a corresponding rewritten version for the written source input.

7. The method of claim 1, wherein deriving the one or more rewriting change measurements comprises:
generating an iterative rewritten version based on one of the one or more rewritten versions of the written source input; and
computing an edit distance between the one of the one or more rewritten versions and the iterative rewritten version.

8. The method of claim 1, wherein deriving the one or more rewriting change measurements comprises:
deriving one or more of: a bag-of-words edit score, or a Levenshtein score.

9. The method of claim 1, wherein the machine learning system is configured to rewrite human-written input content with a lower degree of invariance than for a rewrite machine-generated input content.

10. The method of claim 1, wherein the machine learning system is optimized to rewrite human-written input content with more edits than for a machine-generated input content based on a training dataset that includes multiple human-generated content records drawn from one or more data repositories with content covering a plurality of subject matter domains, respective counterpart machine-generated content records, semantically equivalent to the multiple human-generated content records, produced by one or more other, different, LLM systems, and respective prompts selected at random, for each respective human-generated content record, from a data repository of a plurality of prompts.

11. The method of claim 10, wherein the machine learning system is optimized based on minimizing cross-entropy loss assigned to each training dataset record, wherein the cross-entropy loss represents edit distance between each content record and a corresponding rewritten output produced for the each content record.

12. The method of claim 11, wherein the minimizing of the cross-entropy loss includes performing a calibration loss imposing a threshold value t on an absolute value of the loss on each given input record.

13. A system for detecting machine-generated content, comprising:
an interfacing unit to receive written source input; and
one or more computing devices implementing one or more machine learning models, the one or more computing devices configured to:
generate by a machine learning system configured to transform written content into resultant transformed content, one or more rewritten versions of the written source input, with the one or more rewritten versions being semantically similar to the written source input;
derive one or more rewrite change measurements, for the one or more rewritten versions, representing extent of differences between the one or more rewritten versions and the written source input; and
determine likelihood that the written source input was machine generated based at least on the derived one or more rewriting change measurements.

14. The system of claim 13, wherein the one or more computing devices configured to generate one or more rewritten versions are configured to:
generate multiple rewritten versions of the written source input responsive to respective multiple prompts representative of rewriting instructions, the multiple rewritten versions resulting in increased rewritten diversity produced from the written source input.

15. The system of claim 13, wherein the one or more computing devices configured to generate the one or more rewritten versions of the written source input are configured to:
apply, using the machine learning system, a semantic transformation to the written source input to generate semantically transformed content;
rewrite the semantically transformed content, by the machine learning system, to generate rewritten semantically transformed content; and
apply to the rewritten semantically transformed content, using a machine learning system implementing an inverse semantic transformation model, an inverse semantic transformation of the semantic transformation to produce a corresponding rewritten version for the written source input.

16. The system of claim 13, wherein the one or more computing devices are further configured to:
optimize to rewrite human-written input content with more edits than for a machine-generated input content based on a training dataset that includes multiple human-generated content records drawn from one or more data repositories comprising content from a plurality of subject matter domains, respective counterpart machine-generated content records, semantically equivalent to the multiple human-generated content records, produced by one or more other, different, LLM systems, and respective prompts selected at random, for each respective human-generated content record, from a data repository of a plurality of prompts.

17. The system of claim 16, wherein the one or more computing devices configured to optimize to rewrite human-written input content with more edits than for the machine-generated input are configured to minimize cross-entropy loss assigned to each training dataset record, wherein the cross-entropy loss represents edit distance between each content record and a corresponding rewritten output produced for the each content record, wherein the one or more computing devices configured to minimize the cross-entropy loss are configured to perform a calibration loss process that imposes a threshold value t on an absolute value of the loss on each given input record.

18. A method for optimizing a detection system for detecting machine-generated content, the method comprising:
accessing a training data set for training a rewrite LLM system to rewrite human-written input content with more edits than for a machine-generated input content, the training set comprising multiple human-generated content records drawn from one or more repositories with content covering a plurality of subject matter domains, respective counterpart machine-generated content records, semantically equivalent to the multiple human-generated content records, produced by one or more other, different, LLM systems, and respective prompts selected at random, for each respective human-generated content record, from a data repository of a plurality of LLM-system prompts; and
configuring adjustable parameters of the rewrite LLM system according to an optimization procedure that uses the training dataset to adjust the parameters to cause the rewrite LLM system to rewrite a human-written input content with more edits than for a machine-generated input;
wherein configuring the adjustable parameters according to the optimization procedure comprises minimizing cross-entropy loss assigned to each training dataset record, wherein the cross-entropy loss represents edit distance between each content record and a corresponding rewritten output produced for the each content record.

19. The method of claim 18, wherein minimizing the cross-entropy loss comprises performing a calibration loss process that imposes a threshold value t on an absolute value of the loss on each given input record.

20. The method of claim 18, further comprising:
substituting, for one of the counterpart machine-generated content records, one or more words of the one of the counterpart machine-generated content records with one or more substitute words determined by an auxiliary LLM system, wherein the one or more substitute words maintain part-of-speech consistency and minimally increase perplexity as that of the respective one or more words of the one of the counterpart machine-generated content records.
